(19) United States
(12) Patent Application Publication
(10) Pub. No.: US 2003/0165739 A1
(43) Pub. Date: Sep. 4, 2003

(54) Lithium secondary cell and positive electrode active material, positive plate, and method for manufacturing them

(76) Inventors: Kenichi Kizu, Hyogo (JP); Itaru Gosho, Hyogo (JP); Toshihiro Zushi, Hyogo (JP); Masahiro Kamauchi, Hyogo (JP); Ken Moriuchi, Hyogo (JP)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/296,113

(22) PCT Filed: May 21, 2001
(86) PCT No.: PCT/JP01/04235

(30) Foreign Application Priority Data
May 24, 2000 (JP) 2000-152649
Jun. 1, 2000 (JP) 2000-164577
Jun. 1, 2000 (JP) 2000-164592
Jun. 1, 2000 (JP) 2000-164614
Jun. 5, 2000 (JP) 2000-167310

(51) Int. Cl. H01M 4/52; H01M 4/62; H01M 10/40

(52) U.S. Cl. 429/231.3; 429/232; 429/331; 429/332; 252/182.1

(57) ABSTRACT

Using a crystal (lithium cobaltate) having a crystallite size in the direction of (003) plane of not less than 800 angstrom and a coordination number of a cobalt atom to a different cobalt atom of not less than 5.7 as a positive electrode active material, a lithium ion secondary battery is formed. As a result, the rate characteristic, low temperature characteristic, cycle characteristic and the like of the lithium ion secondary battery can be improved. In addition, by combining a preferable embodiment of the positive plate such as (an embodiment wherein not more than 50% of the surface of a positive electrode active material is covered with a conductive material), (an embodiment wherein two kinds of conductive materials having a particle size of not less than 3 μm and a particle size of not more than 2 μm are used, or one kind of a conductive material having a particle size of not more than 10 μm is used and the porosity of the positive electrode coating layer is 0.08 cc/g-0.14 cc/g), (an embodiment wherein a conductive material containing at least carbon black is used and a specific surface area of the positive electrode coating layer is 0.5 m²/g-1.0 m²/g) and the like, and further incorporating a combination of an embodiment of a preferable negative electrode active material and an electrolyte, a more preferable lithium ion secondary battery having sufficient battery capacity, which is superior in cycle characteristic, preservation property, safety, low temperature characteristic and the like is obtained.

### TECHNICAL FIELD

The present invention relates to a positive electrode active material for lithium ion secondary battery, a positive plate using it and production methods thereof. More specifically, the present invention relates to a lithium ion secondary battery using said positive electrode active material and said positive plate.

### BACKGROUND ART

In general, a lithium ion secondary battery has a structure comprising a separator impregnated with an electrolyte sandwiched between a positive plate and a negative plate. The positive plate and negative plate are prepared by forming a positive electrode coating layer and a negative electrode coating layer comprising a positive electrode active material and a negative electrode active material mixed with a conductive material, a binder and the like on a current collector such as a metal foil and the like. Generally, LiCoO₂ is used as the positive electrode active material, and a carbon material is used as the negative electrode active material.

A lithium ion secondary battery thus constituted has a high energy density and can achieve a high voltage, as compared to a nickel-cadmium battery and the like. Therefore, lithium ion secondary battery has been rapidly adopted as a driving force in recent years for portable devices, such as cellular phones and note type personal computers. Moreover, expansion of the applicable range is expected in the future. Under the circumstances, active research and development of lithium ion secondary battery in an attempt to improve properties of the battery has been ongoing.

The properties of lithium cobaltate to be used as a positive electrode active material for lithium ion secondary battery are easily influenced by crystal structure. In an ideal structure of lithium cobaltate, oxygen atoms (O) form a hexagonal closest packed structure and a cobalt atom (Co) layer and a lithium atom (Li) layer are alternately inserted between oxygen atom layers perpendicular to the c-axis (see FIG. 1). To show the growth of such crystal (crystallinity), a crystallite size is often used as an index. By the crystallite size is meant, as shown in FIG. 2, the size of a single crystal in an active material particle.

With such technical background, it has been conventionally known that control of crystallite size of lithium cobaltate to fall within a particular range is effective for improving cycle characteristic of lithium ion secondary batteries (JP-A-11-322344 etc.).

However, the present inventors have newly found that control of crystallite size of lithium cobaltate to fall within a particular range is insufficient in cycle characteristic in charge and discharge of as many as 500 cycles. In addition, they have also found that, even when the crystallite size, lattice constant, chemical composition and the like are the same, certain active materials show different cycle characteristic, rate characteristic and low temperature characteristic.

The present invention has been completed as a result of intensive studies based on the above-mentioned new findings, and aims at improving cycle characteristic, rate characteristic and low temperature characteristic of lithium ion secondary batteries.

There has been a problem that a lithium ion secondary battery stably exhibiting high quality cannot be produced because, even if a lithium ion secondary battery is produced using the same material, the battery performance may be sometimes superior and may be insufficient in other times.

Another object of the present invention is to provide a high grade positive plate for a high quality lithium ion secondary battery having sufficient battery capacity, which stably affords superior low temperature characteristic, preservation property and cycle characteristic, a preferable production method thereof, and a lithium ion secondary battery using the positive plate.

Taking note of the negative electrode with the hope of providing a more preferable lithium ion secondary battery, use of graphitized carbon as a negative electrode active material for the manufacture of a high capacity lithium ion secondary battery superior in efficiency of the first time charging and discharging is conventionally known. However, such lithium ion secondary battery does not show sufficient charge and discharge cycle characteristic, and repeated charge and discharge problematically degrades rapidly the discharge voltage and discharge capacity. To improve cycle characteristic of a lithium ion secondary battery using such graphitized carbon, the use of cyclic carbonate such as propylene carbonate, ethylene carbonate and the like for an electrolyte has been proposed.

An electrolyte using propylene carbonate as cyclic carbonate is nevertheless inconvenient since it decomposes when used in combination with a negative plate using graphitized carbon. Not only when propylene carbonate alone is used as an electrolyte but also when a mixture of propylene carbonate, ethylene carbonate and chain carbonate is used, the efficiency of the first time charging and discharging is problematically degraded. Even when ethylene carbonate alone is used as cyclic carbonate, impedence is increased due to the high melting point of ethylene carbonate, and the cycle characteristic is adversely influenced.

A yet another object of the present invention is to improve cycle characteristic, efficiency of the first time charging and discharging and capacity of the secondary battery, when graphitized carbon is used as a negative electrode active material and cyclic carbonate is used as an electrolyte of a lithium ion secondary battery.

### DISCLOSURE OF THE INVENTION

With the aim of achieving the above-mentioned object, the present invention provides the following positive electrode active material for lithium ion secondary batteries and a positive plate using same, provides production methods of the positive electrode active material and the positive plate, and provides a lithium ion secondary battery using the positive electrode active material and the positive plate.

Accordingly, the present invention provides the following.

(1) A positive electrode active material for lithium ion secondary battery, wherein lithium cobaltate has a crystallite size in the direction of (003) plane of not less than 800 angstrom and a coordination number of a cobalt atom to a different cobalt atom is not less than 5.7.

(2) A positive plate for lithium ion secondary battery comprising a current collector and a positive electrode coating layer formed thereon, which comprises the positive electrode active material of the above-mentioned (1) and a conductive material having a particle size of not more than 1 μm, wherein not more than 50% of a surface of the positive electrode active material in the positive electrode coating layer is covered with the conductive material. In the following, the embodiment of (2) is referred to as “embodiment (A)” in the explanation.

(3) A positive plate for lithium ion secondary battery comprising a current collector and a positive electrode coating layer formed thereon, which comprises the positive electrode active material of the above-mentioned (1) and a conductive material having a particle size of not less than 3 μm and a conductive material having a particle size of not more than 2 μm, wherein the positive electrode coating layer has a porosity of 0.08 cc/g-0.14 cc/g. In the following, the embodiment of (3) is referred to as “embodiment (B)” in the explanation.

(4) A positive plate for lithium ion secondary battery comprising a current collector and a positive electrode coating layer formed thereon, which comprises the positive electrode active material of the above-mentioned (1) and a conductive material having a particle size of not more than 10 μm, wherein the positive electrode coating layer has a porosity of 0.08 cc/g-0.14 cc/g. In the following, the embodiment of (4) is referred to as “embodiment (C)” in the explanation.

(5) A positive plate for lithium ion secondary battery comprising a current collector and a positive electrode coating layer formed thereon, which comprises the positive electrode active material of the above-mentioned (1) and a-conductive material comprising at least carbon black, wherein the positive electrode coating layer has a specific surface area of 0.5 m²/g-1.0 m²/g. In the following, the embodiment of (5) is referred to as “embodiment (D)” in the explanation.

(6) The positive plate for lithium ion secondary battery according to any of the above-mentioned (1)-(5), wherein the, positive electrode active material has an average particle size of not less than 10 μm.

(7) The positive plate for lithium ion secondary battery according to (6), wherein a value obtained by dividing 20 by a product of an average particle size of the positive electrode active material and a specific surface area of the positive electrode active material is 7-9.

(8) A lithium ion secondary battery comprising a positive plate comprising the positive electrode active material of the above-mentioned (1).

(9) The lithium ion secondary battery of the above-mentioned (8), wherein the above-mentioned positive plate is the positive plate of the above-mentioned (2).

(10) The lithium ion secondary battery of the above-mentioned (8), wherein the above-mentioned positive plate is the positive plate of the above-mentioned (3).

(11) The lithium ion secondary battery of the above-mentioned (8), wherein the above-mentioned positive plate is the positive plate of the above-mentioned (4).

(12) The lithium ion secondary battery of the above-mentioned (8), wherein the above-mentioned positive plate is the positive plate of the above-mentioned (5).

(13) The lithium ion secondary battery of the above-mentioned (8), which comprises a negative plate comprising a graphitized carbon having a spacing of lattice planes (d002) of 0.3350 nm-0.3360 nm, a crystallite size in the c-axis direction (Lc) of not less than 80 nm and a specific surface area of 0.5 m²/g-8 m²/g as a negative electrode active material, and an electrolyte comprising a mixture of ethylene carbonate, propylene carbonate, dimethyl carbonate and at least one kind selected from diethyl carbonate and ethylmethyl carbonate, as a solvent. In the following, the embodiment of (13) is referred to as “embodiment (E)” in the explanation.

(14) The lithium ion secondary battery of the above-mentioned (13), wherein a mixing ratio of at least one kind selected from diethyl carbonate and ethylmethyl carbonate is 25% by volume−50% by volume, a mixing ratio of ethylene carbonate is 4% by volume−20% by volume, a mixing ratio of propylene carbonate is 3% by volume−17% by volume and a mixing ratio of dimethyl carbonate is more than 40% by volume and not more than 60% by volume.

(15) The lithium ion secondary battery of the above-mentioned (13), wherein the-graphitized carbon is at least one kind selected from artificial graphite, natural graphite, boron-doped graphite and mesphase graphitized carbon.

(16) A production method of a positive electrode active material for lithium ion secondary battery, which comprises mixing lithium carbonate and cobalt oxide at a compounding ratio in a lithium/cobalt atom ratio of 0.99-1.10, sintering to give a sintered product mass, pulverizing the sintered product to give a particles and heat treating the particles at a temperature of 400-750°C. for 0.5-50 hr.

(17) The lithium ion secondary battery of the above-mentioned (16), which comprises passing the pulverized particles through a sieve to classify the average particle size of the particles to 1 μm-30μm, prior to the above-mentioned heat treatment.

(18) A production method of a positive plate for lithium ion secondary battery, which comprises coating a positive electrode active material composition comprising the positive electrode active material of the above-mentioned (1) and a conductive material containing at least carbon black on a current collector, drying the composition and rolling at a rolling temperature of 20° C.-100° C. and a rolling rate of 10%-40% to form a positive electrode coat layer.

### BRIEF DESCRIPTION OF THE DRAWINGS

FIG. 1 shows an ideal crystal structure of a lithium cobaltate, wherein a crystal lattice is halved in the c-axis direction.

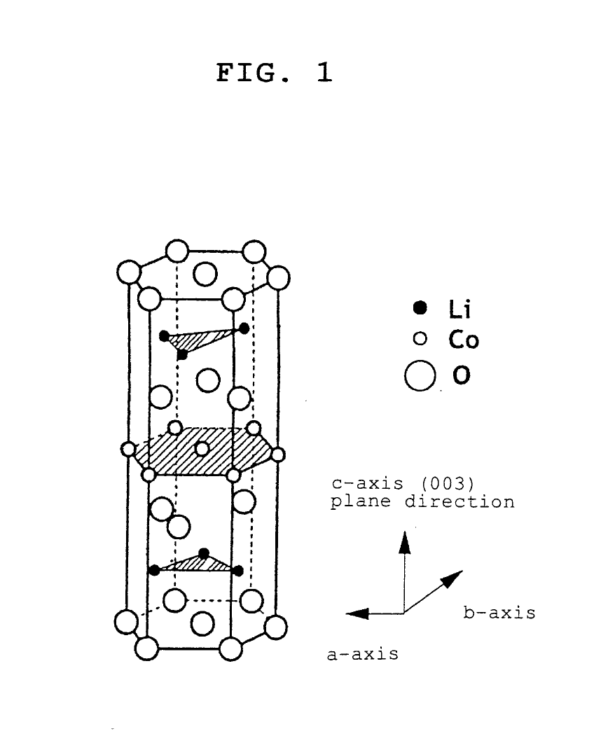

FIG. 2 explains a crystallite size.

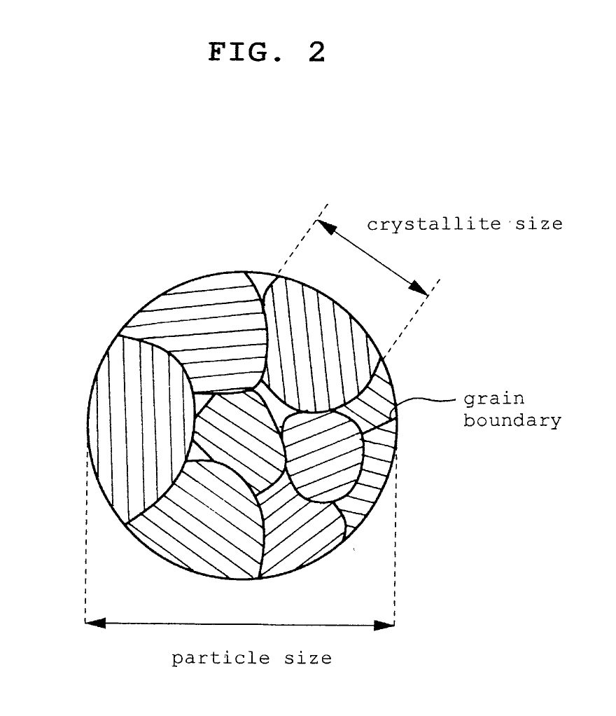

### BEST MODE FOR EMBOYDING THE INVENTION

The positive electrode active material for lithium ion secondary battery of the present invention (hereinafter “positive electrode active material”) is explained first.

In the positive electrode active material of the present invention, the crystallite size in the direction of crystal plane (003) of lithium cobaltate is not less than 800 angstrom, preferably not less than 850 angstrom. The upper limit thereof is not particularly limited but it is preferably not more than 10000 angstrom, more preferably not more than 1000 angstrom. When the crystallite size in the direction of crystal plane (003) is less than 800 angstrom, lithium ion secondary battery shows degraded cycle characteristic, and when it exceeds 10000 angstrom, the battery is susceptible to an influence of crystal distortion due to charge and discharge, thus causing cracks in the crystal to possibly degrade cycle characteristic.

The crystallite size in the direction of crystal plane (003) of lithium cobaltate can be measured by, for example, the following method. A highly pure silicon for X-ray standard substance is pulverized in an agate mortar to a size of not more than 350 mesh sieve, uniformly filled in a sample board, and measured for (111), (220), (311) and (400) peaks of silicon by an X-ray diffractometer (X-ray source: CuKα). During the measurement, the tube voltage and tube current of the X-ray source are maintained constant, and the counting time is adjusted to make intensity of each peak identical. The expansion of the diffraction line of each peak obtained is expressed by integral breadth, which is extrapolated in the diffraction angle that affords (003) peak of lithium cobaltate to determine the expansion of diffraction line caused by the apparatus.

Then a (003) crystal peak of lithium cobaltate is measured using the same apparatus under the same conditions as in the above-mentioned standard substance, the expansion of the diffraction line caused by the crystallite size and the apparatus is determined in the same manner as above. Assuming that the measured expansion of the peak can be approximated by Cauchy function, expansion of the diffraction line caused solely by crystallite size is determined and based on the following formula (I) of Scherrer, the crystallite size is calculated:

$$D = K \cdot \frac{λ}{β \cdot cos θ} \qquad ( I )$$

(D: crystallite size, K: Scherrer constant (=1.05), λ: wavelength of X-ray, β: expansion of diffraction line calculated from integral breadth of peak, θ: diffraction angle)

In the positive electrode active material of the present invention, a coordination number of a cobalt atom to a different cobalt atom is not less than 5.7, preferably not less than 5.8, more preferably not less than 5.9, and the upper limit thereof is 6. When a coordination number of a cobalt atom to a different cobalt atom is less than 5.7, cycle characteristic, rate characteristic and low temperature characteristic of lithium ion secondary battery are degraded.

The coordination number of a cobalt atom to a different cobalt atom in crystal of lithium cobaltate is measured by Extended X-ray Absorption Fine Structure (EXAFS), which is based on the analysis of CoK—edge. To be specific, X-ray absorption spectrum of energy 7200-8700 eV is detected by through transmission, and a coordination number is calculated from the peak caused by Co-Co (atomic distance=2.81 angstrom) of the radial diameter structure function obtained by Fourier transform.

The positive electrode active material of the present invention can be produced through the following step. For example, lithium carbonate and cobalt oxide are mixed at a compounding ratio in a lithium/cobalt atomic ratio of 0.99-1.10, and sintered at 600-1100° C., preferably 700-1000° C., for at least 2 hr, preferably 5-15 hr. A sintered product mass is pulverized to give particles which are heat treated at a high temperature of about 400-750° C., preferably 450-700° C., for 0.5-50 hr, particularly 1-20 hr to give the material. This heat treatment can be performed in the air, in a mixed gas with carbon dioxide gas, or in an inert gas of nitrogen, argon and the like. In view of the possibility of an increased content of impurities due to the production of lithium carbonate when carbon dioxide gas is present in the atmosphere, the heat treatment is preferably carried out under the atmosphere wherein partial pressure of carbon dioxide gas is not more than about 10 mmHg.

It is preferable to pass the pulverized particles through a sieve to classify the pulverized particles prior to the heat treatment. The preferable average particle size after classification is about 1 μm-30 μm, more preferably 5 μm-25 μm. The average particle size may be appropriately determined depending on a preferable embodiment of the positive plate to be mentioned below.

The positive electrode active material of the present invention can improve the cycle characteristic, rate characteristic and low temperature characteristic of lithium ion secondary batteries. By the use of a positive electrode containing the positive electrode active material of the present invention, as a positive electrode of lithium ion secondary battery, a lithium ion secondary battery having the above-mentioned superior property can be obtained.

The lithium ion secondary battery of the present invention comprises the above-mentioned positive electrode active material as a positive electrode, and the constituent elements other than the positive electrode active material may be known. For example, as a binder of the positive electrode active material, polytetrafluoroethylene, poly(vinylidene fluoride), ethylene-propylene-dien polymer and the like can be used. As a conductive material, for example, natural or artificial graphites such as fibrous graphite, scaly graphite, spherical graphite and the like, conductive carbon black and the like can be used. The amount of the binder is about 1 part by weightg—about 10 parts by weight, and the amount of the conductive material is about 3 parts by weight—about 15 parts by weight, per 100 parts by weight of the positive electrode active material composition comprising a positive electrode active material, a binder and a conductive material.

The lithium ion secondary battery of the present invention can be produced according to a known method. For example, the positive plate can be obtained by mixing the positive electrode active material of the present invention, a binder and a conductive material, dispersing them in an organic solvent such as N-methylpyrrolidone and the like to give a paste, coating the paste on a positive electrode current collector, drying, pressing and cutting into a suitable shape.

As more preferable embodiments of the positive plate using the positive electrode active material of the present invention, the embodiments of the above-mentioned (A)-(D) are sequentially explained.

A positive plate of the above-mentioned embodiment (A) is explained.

In the above-mentioned embodiment (A), the positive plate has a positive electrode coating layer and the layer contains the above-mentioned positive electrode active material according to the present invention and a conductive material. The positive electrode coating layer is obtained by forming a layer of a positive electrode active material composition comprising a positive electrode active material and a conductive material on a current collector. The positive electrode coating layer in the present specification refers to that after coating the positive electrode active material composition on the current collector to form a layer, and does not include a positive electrode active material composition before forming.

In the above-mentioned embodiment (A), the positive electrode active material preferably has an average particle size of not less than 10 μm, more preferably not less than 17 μm. When the above-mentioned average particle size is less than 10 μm, abnormal battery reaction tends to occur, unpreferably impairing safety. The average particle size of the positive electrode active material is preferably not more than 25 μm, more preferably not more than 23 μm. When the above-mentioned average particle size exceeds 25 μm, impedence becomes unpreferably high. This applies to the above-mentioned embodiments (B)-(D).

In the above-mentioned embodiment (A), the positive electrode active material has an average particle size of 10 μm or above, and more preferably shows a value obtained by dividing 20 by a product of an average particle size of the positive electrode active material and a specific surface area of the positive electrode active material of 7-9. Namely, particles satisfying the following formula (II) are preferably obtained.

7≦[20/(specific surface area×average particle size)]≦9 (II)

When the above-mentioned 20/(specific surface area×average particle size) is either less than 7 or more than 9, an action to increase the resistive components of the positive electrode active material itself works, which in turn unpreferably degrades cycle characteristic, low temperature characteristic, and further the preservation property. This applies to the above-mentioned embodiments (B)-(D).

The specific surface of the positive electrode active material is preferably set for 0.1 m²/g-0.3 m²/g, particularly 0.15 m²/g-0.25 m²/g. When the above-mentioned specific surface area is less than 0.1 m²/g, the resistive components increase, which in turn unpreferably causes decreases in charge and discharge capacity and rate characteristic. When the above-mentioned specific surface area exceeds 0.3 m²/g, dissociation of oxygen from the active material easily proceeds, unpreferably posing safety problems.

The average particle size of the positive electrode active material can be measured according to the following method. First, the particles to be the measurement target are cast in water or an organic liquid such as ethanol and the like, and dispersed by ultrasonication at about 35 kHz-40 kHz for about 2 minutes. The particles are in such an amount that makes the laser transmittance (quantity of outgoing light/quantity of incident light) of the dispersion after dispersing treatment 70%-95%. Then, the dispersion is subjected to a microtrack particle size analyzer and the particle size (D1, D2, D3 . . . ) of particles, and the number (N1, N2, N3 . . . ) of particles having each particle size are measured based on the diffusion of a laser beam.

In the microtrack particle size analyzer, the particle size distribution of the spherical particle group having a theoretical intensity most close to the observed scattering intensity distribution is calculated. To be specific, particles are assumed to be spheres having cross sectional circle having the same area as a projection image obtained by irradiation of laser beam, and the diameter of the cross sectional circle (diameter corresponding to sphere) is measured as a particle size.

The average particle size (μm) is calculated from the following formula (III) using the particle size (d) of each particle and the number (N) of particles having each particle size, which are obtained above.

average particle size (μm)=(ΣNd³/ΣN)^{1/3} (III)

The specific surface area of the positive electrode active material can be measured by the gas phase adsorption method (single-point method) wherein nitrogen is an adsorbate, from among the adsorption methods described in Material Chemistry of Fine Particles, Yasuo Arai, first edition, 9th printing, Baifukan (Tokyo), pp. 178-184 (1995). Such measurement of the specific surface area utilizing a gas phase adsorption method using nitrogen as an adsorbate is preferably done using, for example, a specific surface area meter monosorb (QUANTA CHROME CORPORATION) and the like.

In the above-mentioned embodiment (A), a positive electrode coating layer has a granular conductive material. The “granular” in the present invention includes, but not particularly limited to, scaly, spherical, pseudo-spherical, bulky, whisker-like and the like.

As the conductive material, carbon materials such as artificial or natural graphites, or carbon black such as Ketjen black, acetylene black, oil furnace black, extraconductive furnace black and the like, and the like can be used.

The conductive material makes the surface of positive electrode active material particles conductive. Therefore, those having a greater size provides a poor action. Thus, a conductive material has a particle size of not more than 1 μm, preferably not more than 0.5 μm, particularly preferably not more than 0.1 μm. The use of a conductive material having a particle size of not less than 0.001 μm is preferable. The use of a conductive material having a specific surface area of note less than 1 m²/g, particularly 10 m²/g-1000 m²/g, is preferable.

The particle size of the conductive material refers to a diameter (diameter corresponding to sphere) of a cross sectional circle assuming the particles constituting the conductive material to be spherical and can be measured using an electron microscope. To be specific, magnification is set such that at least 20 particles are within the view first and they are photographed with an electron microscope. The area of the particle images on the photograph is calculated, and from the calculated area, the diameter of a circle having the area is calculated. Assuming that the particles constituting the conductive material are spheres having the cross sectional circle of this diameter, this diameter becomes the particle size of the conductive material.

The specific surface area of the conductive material can be measured by a gas phase adsorption method (single-point method) using nitrogen as an adsorbate, in the same manner as in the aforementioned positive electrode active material.

The amount of the conductive material to be used may be the same as in conventional cases, where it is used in an amount of, for example, 0.5 part by weight-10 parts by weight, more preferably 2 parts by weight-8 parts by weight, per 100 parts by weight of the positive electrode active material.

In the above-mentioned embodiment (A), the conductive material is more preferably realized by a mixture of the above-mentioned conductive material having a particle size of not more than 1 μm (hereinafter to be referred to as “conductive material (A1)” and a granular conductive material having a particle size greater than that (hereinafter to be referred to as “conductive material (A2)”. In this case, the conductive material (A1) having a smaller size gathers on the particle surface of the positive electrode active material to make the surface conductive, and the conductive material (A2) having a greater size enters between conductive positive electrode active material particles to electrically connect the particles. As a result, sufficient electrical conduction on the surface and within the positive electrode active material can be obtained to reduce resistive component of the positive plate itself.

As the conductive material (A2), carbon materials conventionally used for lithium ion secondary battery can be used, as in the case of conductive material (A1). As the carbon materials, artificial or natural graphites, carbon black such as acetylene black, oil furnace black, extraconduczive furnace black and the like, and the like are mentioned. The conductive material (A2) makes the electrical connection between particles of a positive electrode active material fine. Thus, too small the material makes the electrical connection difficult to achieve. On the other hand, too large a conductive material (A2) prevents closest packing of the positive electrode active material. As a conductive material (A2), therefore, those having a particle size of not less than 3 μm, preferably not less than 5 μm, are used. In addition, the use of a conductive material (A2) having a particle size of not more than 25 μm is preferable. Moreover, the use of a conductive material (A2) having a specific surface area of not less than 2 m²/g, particularly 5 m²/g-1000 m²/g, is preferable.

In the present invention, the particle size of the conductive material refers to a diameter (diameter corresponding to sphere) of a cross sectional circle assuming the particles constituting the conductive material to be spherical and can be measured using a microtrack particle size analyzer, as in the case of the aforementioned positive electrode active material.

When the particle size is less than 1 μm, particle agglomerate tends to be produced in a dispersion. Thus, the use of an electron microscope is preferable, when the particle size is less than 1 μm. To be specific, magnification is set such that at least 20 particles are within the view first and they are photographed with an electron microscope. The area of the particle images on the photograph is calculated, and from the calculated area, the diameter of a circle having the area is calculated. Assuming the particles constituting the conductive material are spheres having the cross sectional circle of this diameter, this diameter becomes the particle size of the conductive material.

As the conductive material, graphites, particularly graphitized carbon having a spacing of lattice planes (d002) of not more than 0.34 nm and a crystallite size in the c-axis direction (Lc) of not less than 10 μnm is preferably used.

The spacing of lattice planes (d002) and a crystallite size in the c-axis direction (Lc) in the present invention can be measured according to Japan Society for the Promotion of Science Method, which is concretely explained in the following.

Highly pure silicon for X-ray standard substance is pulverized in an agate mortar to a size of not more than 325 mesh standard sieve to give a standard substance. This standard substance and a specimen to be measured (graphitized carbon) are mixed in an agate mortar (graphitized carbon: 100 wt %, standard substance: 10 wt %) to give a specimen for X-ray. This specimen for X-ray is uniformly filled in a sample board of an X-ray diffractometer (RINT2000 manufactured by RIGAKU ELECTRIC CORPORATION, X-ray source: CuKα ray). The 002 peak of carbon and 111 peak of the standard substance are measured under the conditions of voltage applied to X-ray tube 40 kV, applied current 50 mA, scanning range 2θ=23.5°-29.5°, scanning speed 0.25 degree/min. Using a graphitization calculation soft equipped with the above-mentioned X-ray diffractometer, the spacing of lattice planes (d002) and crystallite size (Lc) in the c-axis direction are calculated from the obtained positions of the peaks and half-width thereof.

With regard to the mixing ratio of the conductive aterial (A1) and conductive material (A2), too small or too large a mixing ratio of one of them may encourage steep descending of discharge in the initial stage of discharge. Therefore, the amount of the conductive material (A1) in the present invention is preferably 1 part by weight−200 parts by weight, particularly 2 parts by weight−100 parts by weight, per 100 parts by weight of the conductive material (A2). To improve conductivity and safety, it is preferably 5 parts by weight−100 parts by weight, particularly 10 parts by weight−50 parts by weight.

The total amount of use of the conductive material (A1) and the conductive material (A2) may be, as in conventional cases, for example, about 3 parts by weight−15 parts by weight per 100 parts by weight of the positive electrode active material. When two kinds of conductive materials having different sizes are to be used, sufficient electrical connection can be afforded between positive electrode active material particles even by the use of an amount smaller than conventional, such as about 3 parts by weight−about 10 parts by weight, per 100 parts by weight of the positive electrode active material. As a result, the amount of the positive electrode active material can be increased, and the battery capacity can be increased.

As the binder to form a positive electrode coating layer, those conventionally used, such as polytetrafluoroethylene, poly(vinylidene fluoride), polyethylene, ethylene-propylene-dien polymer and the like, are preferably used. This binder is contained in an amount of preferably 1 part by weight−10 parts by weight, more preferably 2 parts by weight−8 parts by weight, per 100 parts by weight of the positive electrode active material.

In the present invention, the current collector used for a positive plate may be, for example, a conventionally used one, such as a foil, an expanded metal and the like, formed from aluminum, aluminum alloy, titanium and the like.

As mentioned above, the positive plate according to the above-mentioned embodiment (A) has a positive electrode coating layer formed on a current collector from a positive electrode active material through a series of steps to be mentioned later. In this embodiment, not more than 50%, preferably not more than 40%, more preferably not more than 30%, of a surface of the positive electrode active material is covered with a conductive material (when the conductive material is the above-mentioned mixture, covered with conductive material (A1)) in a positive electrode coating layer. When the conductive material covers more than 50% of a surface of the positive electrode active material, an electrolyte contacts the surface of the positive electrode active material less frequently and the mobility of lithium is degraded, as a result of which the battery properties such as rate characteristic at room temperature (20° C.), low temperature characteristic and the like may be degraded. In the above-mentioned case, moreover, most of the surface of the positive electrode active material is covered and the apparent surface area of the positive electrode active material increases. Consequently, oxygen release from the positive electrode active material easily proceeds, posing a problem in terms of safety. In the above-mentioned embodiment (A), a conductive material preferably covers not less than 5%, more preferably not less than 10%, particularly preferably not less than 20%, of a surface of the positive electrode active material. When the positive electrode active aterial covers only less than 5% of the surface, sufficient conductivity cannot be achieved. This results in insufficient conductivity obtained and inconvenient increase in the resistance of electrode, decrease in battery capacity or egradation of cycle characteristic.

The proportion of the surface of the positive electrode active material covered with a conductive material in such positive electrode coating layer can be evaluated by a conventionally known method based on elemental analysis using an Electron Probe Micro Analysis (EPMA). To be specific, an optional portion of the positive plate is cut out and subjected to gold evaporation by sputtering to impart conductivity to give a sample. This sample is subjected to an elemental analysis for carbon element using X-ray micro analyzer JXA-8600MA (JEOL Ltd.). From the element mapping thereof, the proportion of carbon element in the entire sample is calculated to determine the proportion of the surface of the positive electrode active material to be covered with a conductive material.

The above-mentioned proportion can be also determined by image analysis using a scanning electron microscope (SEM) photograph. To be specific, an optional portion of the positive plate is cut out in 1 cm×1 cm and subjected to gold evaporation by sputtering to impart conductivity to give a sample. An optional 100 μm×100 μm area of this sample is observed with a scanning electron microscope, and the surface area of the positive electrode active material to be covered with a conductive material is determined by image analysis, after which the proportion of this surface in the entire sample is calculated.

In the following, a preferable example of the method for forming a positive electrode coating layer in the above-mentioned embodiment (A) is shown. This forming method basically comprises (1) mixing step, (2) coating step, (3) drying step and (4) rolling step.

(1) In the mixing step, the above-mentioned positive electrode active material composition is mixed for uniform dispersion in a conventionally known N-methylpyrrolidone using a conventionally known mixing device such as Planetary Despa (manufactured by ASADA IRON WORKS CO., LTD.) and the like to give a slurry.

The conditions specific to the above-mentioned embodiment (A) for the mixing step include first feeding the total amount of a positive electrode active material and a conductive material and adding a solution of poly(vinylidene fluoride) (PVdF) in an N-methylpyrrolidone solution to impart a certain level of viscosity to the entire material. In this state, the material is stirred in a planetary at 10 rpm-30 rpm, and in Despa at 500 rpm-1000 rpm for about 10 min-about 30 min. Thereafter, a solution of poly(vinylidene fluoride) in N-methylpyrrolidone is added in 2 or 3 portions until a given viscosity is afforded. During this operation, stirring is maintained in a planetary at 5 rpm-20 rpm, in Despa at 500 rpm-2000 rpm.

In the subsequent (2) coating step, the slurry obtained as mentioned above is applied on a current collector. The slurry is coated using a conventionally known instrument such as a comma roller type or die coat type coater and the like, as generally performed in this field.

In (3) drying step, the slurry applied on a current collector is dried using a conventionally known instrument such as hot wind dry furnace and the like in a temperature rang of from 100° C. to 200° C. for 5 min to 20 min.

Subsequently in (4) rolling step, the above-mentioned slurry dried on the current collector is rolled into a layer using an apparatus such as a roll press machine and the like to form a positive electrode coating layer. In the present invention, rolling is applied under the rolling conditions wherein the rolling temperature is preferably set for 20°C.-100° C., more preferably 25° C.-50°C., particularly preferably 30° C., and the rolling ratio is preferably set for 10%-40%, more preferably 20%-40%, particularly preferably 30%.

When the rolling temperature and the rolling ratio are both lower than the above-mentioned ranges, spring back occurs due to low temperature rolling and the obtained lithium ion secondary battery shows lower safety. In addition, the designed capacity may not be obtained or adhesion between the coating layer and the current collector becomes unpreferably low, due to low rolling rate rolling. When the rolling temperature and the rolling ratio both exceed the above-mentioned range, impregnation may not proceed during impregnation of an electrolyte due to high temperature rolling, making an electrode having a high resistance. In addition, the high rolling unpreferably and inconveniently degrades the rate characteristic markedly. When the rolling ratio is within the above-mentioned range and the rolling temperature is less than the above-mentioned range, the designed capacity can be achieved. However, the obtained lithium ion secondary battery unpreferably shows lower safety due to spring back. When the rolling ratio is within the above-mentioned range and the rolling temperature exceeds the above-mentioned range, the designed capacity can be achieved. However, due to the insufficient impregnation of the electrolyte, the electrode has a greater resistance, which is not preferable. Furthermore, when the rolling temperature is within the above-mentioned range and the rolling ratio is lower than the above-mentioned range, the rolling cannot be performed sufficiently, and the cycle characteristic is unpreferably and inconveniently degraded due to lower adhesion between the coating layer and the current collector. When the rolling temperature is within the above-mentioned range and the rolling ratio exceeds the above-mentioned range, the rate characteristic is unpreferably and inconveniently degraded. As used herein, by the above-mentioned rolling temperature is meant the temperature of the material to be subjected to a roll processing during the processing, and by the above-mentioned rolling ratio is meant the degree of roll processing, which is also called a draft and the like. The rolling ratio calculated according to the following formula (IV), wherein a thickness before rolling is h1, a thickness after rolling is h2, and a thickness of a current collector is h3.

rolling ratio (%)=(h1−h2)×100/(h1−h3) (IV)

The positive plate of the above-mentioned embodiment (B) is explained next.

In the above-mentioned embodiment (B), the positive plate is, as in the above-mentioned embodiment (A), has a positive electrode coating layer whose porosity is 0.08 cc/g-0.14 cc/g.

In the above-mentioned embodiment (B), two kinds of conductive materials having a different size are used, and in the above-mentioned embodiment (C), one kind of conductive material is used.

In the above-mentioned embodiment (B), a mixture of a conductive material having a greater granular size (hereinafter to be referred to as “conductive material (Bl)”) and a conductive material having a smaller granular size (hereinafter to be referred to as “conductive material (B2)”) is used. The basic action and effect due to the smaller and greater sizes of the two is as described in the above-mentioned (A).

The materials of the conductive materials (B1) and (B2) are the same as those mentioned for the above-mentioned conductive material (A1) and (A2).

The conductive material (B1) is used to make the electrical connection between particles of positive electrode active material fine. Too small a size thereof makes the achievement of the electrical connection difficult. In contrast, when the conductive material (B1) is too large, it prevents closest packing of the positive electrode active material. Therefore, the conductive material (B1) to be used has a particle size of not less than 3 μm, preferably not less than 5 μm. The conductive material (B1) to be used preferably has a particle size of not more than 25 μm. The conductive material (B1) to be used preferably has a specific surface area of not more than 20 m²/g, particularly 1 m²/g-10 m²/g.

The conductive material (B2) is used for make the particles surface of a positive electrode active material conductive. When it is too large, such action becomes poor. Therefore, the conductive material (B2) to be used preferably has a particle size of not more than 2 μm, preferably not more than 1 μm. The conductive material (B2) to be used preferably has a particle size of not less than 0.0001 μm. The conductive material (B2) to be used preferably has a specific surface area of not less than 10 m²/g, particularly 15 m²/g-1000 m²/g.

The mixing ratio and the total amount of use of the conductive material (B1) and the conductive material (B2) are the same as those mentioned for the above-mentioned embodiment (A).

The positive plate of the above-mentioned embodiment (C) is explained next.

In the above-mentioned embodiment (C), a conductive material of a single granular kind (hereinafter to be referred to as “conductive material (C)”) is used instead of two kinds of conductive materials (B1) and (B2) having different sizes in the above-mentioned embodiment (B). The conductive material (C) has a particle size of not more than 10 μm, preferably not more than 8 μm. The conductive material (C) to be used preferably has a particle size of not less than 0.1 μm. The conductive material (C) to be used preferably has a specific surface area of not more than 100 m²/g, particularly 0.1 m²/g-50 m²/g.

The definitions of particle size of conductive material, measurement method, material and the amount of use thereof are as explained for the above-mentioned embodiment (A).

In the above-mentioned embodiment (C), a single kind of a conductive material having a particle size of not more than 10 μm is used. As a result, stable dispersing state can be achieved in the mixing step to be mentioned later and a lithium ion secondary battery having a stable quality can be preferably produced.

The porosity of a positive electrode coating layer can be controlled by rolling conditions in a rolling step, as mentioned later, but under the same rolling conditions, the porosity varies depending on the kind of the binder to be used. The binder to be used in the above-mentioned embodiment (C) is as mentioned above. When a binder is added in an amount of 3 parts by weight per 100 parts by weight of the positive electrode active material under rolling conditions of rolling temperature 30° C., rolling ratio 30%, a positive electrode coating layer having a porosity of 0.08 cc/g-0.13 cc/g can be formed using, for example, poly(vinylidene fluoride) as a binder, a positive electrode coating layer having a porosity of 0.09 cc/g-0.14 cc/g can be formed using polytetrafluoroethylene, and a positive electrode coating layer having a porosity of 0.08 cc/g-0.13 cc/g can be formed using an ethylene-propylene-dien type polymer.

As mentioned above, the positive plate of the present invention has a positive electrode coating layer of a positive electrode active material composition formed on a current collector by a series of steps to be mentioned below. In the present invention, a positive electrode coating layer has a porosity of 0.08 cc/g-0.14 cc/g, preferably 0.09 cc/g-0.12 cc/g, as measured by a porosimeter method using mercury. When the porosity of the positive electrode coating layer is less than 0.08 cc/g, the lithium ion secondary battery inconveniently shows degraded low temperature characteristic and cycle characteristic, and when the porosity conversely exceeds 0.14 cc/g, the lithium ion secondary battery inconveniently has a smaller battery capacity.

In the following, one preferable example of a method for forming a positive electrode coating layer in the embodiments of the above-mentioned (B) and (C) is shown. The forming method basically consists of (1) mixing step, (2) coating step, (3) drying step and (4) rolling step, as in the above-mentioned embodiment (A).

(1) In the mixing step, the above-mentioned positive electrode active material composition is mixed for uniform dispersion in conventionally known N-methylpyrrolidone using a conventionally known mixing device such as planetary Despa (manufactured by ASADA IRON WORKS CO., LTD.) and the like to give a slurry, as generally performed in this field.

The (2) coating step, (3) drying step and (4) rolling step are basically the same as the above-mentioned embodiment (A), but in the rolling step, the rolling conditions, or rolling temperature and rolling ratio, are determined in particular ranges to control the porosity of the formed positive electrode coating layer. The rolling is performed under the rolling conditions wherein rolling temperature is preferably 20° C.-100° C., more preferably 25° C.-50° C., particularly preferably 30° C., and the rolling ratio is preferably 10%-40%, more preferably 20%-40%, particularly preferably 30%.

By forming a positive electrode coating layer having the above-mentioned porosity by applying rolling under such rolling conditions, a lithium ion secondary battery capable of overcoming inconvenience of inferior low temperature characteristic and cycle characteristic due to too small a porosity of a positive electrode coating layer can be preferably produced, unlike conventional lithium ion secondary batteries having a positive plate having a positive electrode coating layer formed under rolling conditions of rolling temperature of 20° C.-150° C. and a rolling ratio of 20%-40%.

The thickness of the positive electrode coating layer is the same as in the above-mentioned embodiment (A).

The production method of a positive plate for lithium ion secondary battery, which includes formation of a positive electrode coating layer under the aforementioned rolling conditions is only one example of preferable production method for producing the positive plate for lithium ion secondary battery of the present invention, and the positive plate for lithium ion secondary battery of the present invention is not limited to those produced by such method.

The lithium ion secondary battery of the present invention further has, in addition to the above-mentioned positive plate, a negative plate and an electrolyte. These are not particularly limited and can be preferably realized using conventionally known materials. In the following, preferable examples of negative plate and electrolyte used in the present invention are shown.

The positive plate of the above-mentioned embodiment (D) is explained now.

In the above-mentioned embodiment (D), the positive plate has, like the above-mentioned embodiment (A), a positive electrode coating layer, and this layer comprises a positive electrode active material of the present invention and at least carbon black as a conductive material, and has a specific surface area of preferably 0.5 m²/g-1.0 m²/g, more preferably 0.7 m²/g-0.9 m²/g.

In the above-mentioned embodiment (D), at least a carbon black conductive material is used. The carbon black used is granular, and may be, for example, Ketjen black, acetylene black, oil furnace black, extraconductive furnace black and the like. Of these, Ketjen black is particularly preferably used. Examples of the carbon black include those having a particle size of preferably 0.001 μm-1 μm, more preferably 0.005 μm-0.1 μm. The carbon black to be used preferably has a specific surface area of 1 m²/g-10000 m²/g, particularly preferably 10 m²/g-1000 m²/g.

The definition of the particle size of carbon black and the measurement method thereof are as explained for the above-mentioned embodiment (A), and the measurement method of specific surface area is as mentioned above.

The amount of carbon black to be used is, for example, 0.2 part by weight−3.0 parts by weight, more preferably 0.5 part by weight−2.0 parts by weight, per 100 parts by weight of the positive electrode active material.

In the above-mentioned embodiment (D), the conductive material is preferably realized by a mixture containing, besides the above-mentioned carbon black (hereinafter to be referred to as “conductive material (D1)”), a different granular conductive material (hereinafter to be referred to as “conductive material (D2)”).

As the conductive material (D2), one having a greater size as compared with carbon black, which is a conductive material (D1), is preferably used. The basic action and effect due to the smaller and greater sizes of the two is as described in the above-mentioned (A).

As the material of the above-mentioned conductive material (D2), carbon material can be used as in the above-mentioned embodiment (A).

The conductive material (D2) makes the electrical connection between particles of a positive electrode active material fine. Thus, too great the material makes the electrical connection difficult to achieve. On the other hand, too small a conductive material (D2) prevents closest packing of the positive electrode active material. As a conductive material (D2), therefore, those having a particle size of 1 μm-100 μm, more preferably 2 μm-10 μm, are used. Moreover, the conductive material (D2) to be used preferably has a specific surface area of not more than 20 m²/g, particularly 1 m²/g-10 m²/g.

The definition and measurement method of the particle size of the conductive material, and the mixing ratio and the total amount of use of the conductive material (D1) and the conductive material (D2) are the same as those mentioned for the above-mentioned embodiment (A).

In addition to the conductive material (D1) and conductive material (D2), a third conductive material selected from those exemplified for the above-mentioned conductive material (D2) may be further added. The third conductive material to be preferably used may be, for example, scaly graphite having a particle size (corresponding spherical diameter) of preferably 1 μm-100 μm, more preferably 3 μm-10 μm, and a specific surface area of preferably 0.1 m²/g-100 m²/g, more preferably 1 m²/g-10 m²/g.

As the mixing ratio of the conductive material (D1), conductive material (D2) and a third conductive material, 100 parts by weight−1000 parts by weight of conductive material (D2) and 100 parts by weight−1000 parts by weight of a third conductive material are preferably contained, per 100 parts by weight of conductive material (D1). The total amount of use of the conductive material (D1), conductive material (D2) and a third conductive material is, like the above-mentioned case, or example, about 3 parts by weight−15 parts by weigh per 100 parts by weight of the positive electrode active material.

As a binder for forming the positive electrode coating layer, those used in the above-mentioned embodiment (A) can be used. The binder is added in an amount of preferably 1 part by weight−10 parts by weight, more preferably 2 parts by weight−7 parts by weight, per 100 parts by weight of the positive electrode active material.

As mentioned above, the positive plate of the above-mentioned embodiment (D) has a positive electrode coating layer as a layer formed using a positive electrode active material on current collector by a series of steps to be mentioned below. In this embodiment, the positive electrode coating layer has a specific surface area of 0.5 m²/g-1.0 m²/g, preferably 0.6 m²/g-0.9 m²/g, more preferably 0.7 m²/g-0.8 m²/g. When the above-mentioned specific surface area is less than 0.5 m²/g, impregnation does not proceed sufficiently during impregnation of electrolyte and causes increase in the resistance of the entire battery, which in turn inconveniently degrades rate characteristic and cycle characteristic. When the above-mentioned specific surface area conversely exceeds 1.0 m²/g, impregnation of electrolyte becomes sufficient but the objective rolling ratio cannot be achieved. Inconveniently, therefore, a battery satisfying the designed capacity of the battery cannot be afforded.

The specific surface area of the positive electrode coating layer can be preferably measured using, for example, a specific surface-area meter monosorb (QUANTA CHROME CORPORATION), in the same manner as in the measurements of the specific surface area of the above-mentioned positive electrode active material and conductive material.

In the above-mentioned embodiment (D), a conductive material is required to comprise at least carbon black and have a specific surface area of the positive electrode coating layer of 0.5 m²/g-1.0 m²/g. In other words, a mere use of carbon black as a conductive material or merely setting the specific surface area of positive electrode coating layer within the above-mentioned range fails to achieve the effect of the embodiment. A high quality lithium ion secondary battery having sufficient battery capacity, which stably affords superior low temperature characteristic, preservation property and cycle characteristic, can be obtained only when it comprises carbon black and has a specific surface area of the positive electrode coating layer within the above-mentioned range.

In the following, one preferable example of a method for forming a positive electrode coating layer in the embodiment of the above-mentioned (D) is shown. The forming method basically consists of (1) mixing step, (2) coating step, (3) drying step and (4) rolling step, as in the above-mentioned embodiment (A).

The (1) mixing step, (2) coating step, (3) drying step and (4) rolling step are basically the same as the above-mentioned embodiments (B) and (C).

By applying rolling under such rolling conditions, a positive electrode coating layer can be preferably formed to make its specific surface area within the above-mentioned range, unlike conventional lithium ion secondary batteries having a positive plate having a positive electrode coating layer formed under rolling conditions of rolling temperature of 50° C.-150° C. and a rolling ratio of 20%-40%. Therefore, a lithium ion secondary battery comprising carbon black as a conductive material, wherein a specific surface area of the positive electrode coating layer is within the above-mentioned range, can be preferably produced as mentioned above, and a high quality lithium ion secondary battery having sufficient battery capacity, which stably affords superior low temperature characteristic, preservation property and cycle characteristic, can be produced, because, unlike conventional lithium ion secondary batteries, it is free of inconsistent sufficiency in superiority in the above-mentioned battery performance, which has been found even if the same material is used to produce the battery.

In any of the above-mentioned,embodiments, the thickness of the positive electrode coating layer in the present invention is not particularly limited. It is formed such that the thickness is preferably 80 μm-200 μm, more preferably 120 μm-160 μm. When the thickness of the positive electrode coating layer is less than 80 μm, charge and discharge capacity may be decreased due to insufficient amount of coating, or degradation of rate characteristic and low temperature characteristic due to excessive rolling may occur, which is inconvenient and unpreferable. The above-mentioned thickness exceeding 200 μm is inconvenient and unpreferable, because the adhesion between the coating layer and the current collector becomes dramatically poor, and the cycle characteristic may be degraded. In addition, the outer diameter of a wound product obtained by winding positive plate and the negative plate via a separator, as mentioned below, exceeds the designed value, making insertion of the wound product into a battery can unattainable.

The method for forming the aforementioned positive electrode coating layer is only one example of preferable production methods and the positive plates of the embodiments of the above-mentioned (A)-(D) are not limited to those produced by the above-mentioned method.

The negative plate, electrolyte and the like necessary for constituting the lithium ion secondary battery may be known.

As the negative electrode active material, graphites such as fibrous graphite, scaly graphite, spherical graphite and the like, preferably fiber mesophase graphitized carbon, can be used. As a binder of the negative electrode active material, the same binders as those for the above-mentioned positive electrode active material can be used. The amount of negative electrode active material to be used is about 80 parts by weight−96 parts by weight, per 100 parts by weight of the total amount of the negative electrode active material and the binder.

As the negative electrode current collector (the same for positive electrode current collector), a foil or a perforated foil and the like, which are formed from a conductive metal, can be used, wherein the thickness thereof is about 5 μm-about 100 μm. As the material for the negative electrode current collector, copper, nickel, silver, stainless steel and the like are used, and foil and expanded metal are preferable embodiments, which may be perforated. The negative electrode active material layer may contain a conductive material, where necessary.

As the electrolyte, one obtained by dissolving a lithium salt such as LiClO₄, LiBF₄, LiPF₆ and the like in an organic solvent such as ethylene carbonate, propylene carbonate, dimethyl carbonate, diethyl carbonate, ethylmethyl carbonate, γ-butyrolactone and the like, can be used.

Preferable examples of the negative plate and electrolyte are now explained in detail.

The negative plate is obtained by forming a negative electrode coating layer, which is obtained by mixing a negative electrode active material and a binder and the like, on a current collector. As the negative electrode active material, a carbon material can be used, like the conventionally known negative electrode active material. As such carbon material, graphitized carbon having a specific surface area of preferably not more than 2.0 m²/g, more preferably 0.5 m²/g-1.5 m²/g, a spacing of lattice planes (d002) of preferably not more than 0.3380 nm, more preferably 0.3355 nm-0.3370 nm, and a crystallite size in the c-axis direction (Lc) of preferably not less than 30 nm, more preferably 40 nm-70 nm, is particularly preferably used. As the graphitized carbon satisfying the above-mentioned numeral ranges, for example, mesophase graphitized carbon is mentioned.

When the specific surface area is greater than 2.0 m²/g, a decomposition reaction of propylene carbonate, which is an electrolyte component, occurs during charging to unpreferably degrade the battery capacity. When the spacing of lattice planes (d002) exceeds 0.3380 nm or a crystallite size in the c-axis direction (Lc) is less than 30 nm, the potential of the negative plate may increase to unpreferably lower the average discharge potential of the battery.

In the present invention, the graphitized carbon is used in a granular state, like a typical graphite type negative electrode active material. The particles constituting the graphitized carbon are not particularly limited in shape, and they can be scaly, fibrous, spherical, pseudo-spherical, bulky, whisker and the like. However, from the aspects of easiness of coating a current collector and possible orientation of particles after coating, the graphitized carbon is preferably fibrous.

Thus, a fibrous mesophase type graphitized carbon, namely, mesophase type graphitized carbon fiber, is particularly preferably used. A mesophase type graphitized carbon fiber can be produced by, for example, the following method.

First, a pitch such as petroleum pitch, coal tar pitch and the like is spun into a fiber having a length of about 200 μm-300 μm by a melt blow method. As the pitch, use of mesophase pitch containing mesophase in a proportion of not less than 70% by volume is particularly preferable. This fiber is carbonized at 800° C.-1500° C., and pulverized into a fiber having a suitable size such as an average fiber length of about 1 μm-100 μm and an average fiber diameter of about 1 μm-15 μm. The pulverized fiber is heated at 2500° C.-3200° C., preferably 2800° C.-3200° C., for graphitization to give a mesophase type graphitized carbon fiber.

For fine coatability of the negative electrode active material to be mentioned later to the negative electrode current collector, the above-mentioned pulverization is preferably performed to make the average fiber length 1 μm-100 μm, particularly 2 μm-50 μm, further 3-25 μm, and the average fiber diameter 0.5 μm-15 μm, particularly 1 μm-15 μm, further 5 μm-10 μm. The aspect ratio (average fiber length/average fiber diameter ratio) is preferably 1-5.

In the present invention, the measurement of the specific surface area of graphitized carbon is, like the aforementioned measurement of the specific surface area of the positive electrode active material, performed according to a gas phase adsorption method (single-point method) using nitrogen as an adsorbate and, for example, a specific surface area meter monosorb (QUANTA CHROME CORPORATION) and the like, from among the adsorption methods described in Material Chemistry of Powder, Yasuo Arai, first edition 9th printing, Baifukan (Tokyo), 1995, pp. 178-184.

In the present invention, moreover, the spacing of lattice planes (d002) and a crystallite size in the c-axis direction (Lc) of graphitized carbon can be measured according to Japan Society for the Promotion of Science Method, as in the case of the aforementioned conductive material.

In the lithium ion secondary battery of the present invention, as the binder to be used together with the negative electrode active material, polytetrafluoroethylene, poly(vinylidene fluoride), polyethylene, ethylene-propylene-dien type polymer and the like can be used as in the conventional cases.

In the present invention, the negative electrode coating layer may contain a conductive material as necessary. In this case, the conductive material is exemplified by natural graphite, artificial graphite, carbon black and the like, having an average particle size of not more than 5 μm.

As the solvent of the electrolyte of the present invention, a mixture containing at least one kind selected from diethyl carbonate (DEC) and ethylmethyl carbonate (EMC), and ethylene carbonate (EC), propylene carbonate (PC) and dimethyl carbonate (DMC) is used.

The mixing ratio of each component constituting the above-mentioned mixture is preferably 25% by volume-50% by volume, more preferably 30% by volume-35% by volume, for the at least one kind selected from diethyl carbonate and ethylmethyl carbonate. The mixing ratio is preferably 4% by volume-20% by volume, more preferably 6% by volume-18% by is volume, for ethylene carbonate. The mixing ratio is preferably 3% by volume-17% by volume, more preferably 5% by volume-15% by volume, for propylene carbonate. The mixing ratio is preferably above 40% by volume and not more than 60% by volume, more preferably 45% by volume-55% by volume, for dimethyl carbonate. When both diethyl carbonate and ethylmethyl carbonate are mixed in the electrolyte of the present invention, the total amount of these should satisfy the above-mentioned mixing ratio.

When the above-mentioned mixing ratio of at least one kind selected from diethyl carbonate and ethylmethyl carbonate is less than 25% by volume, the electrolyte shows an increased freezing point, which increases resistance in the battery particularly under a low temperature of not higher than −20° C., and sometimes unpreferably degrades charge and discharge cycle characteristic and low temperature characteristic. On the other hand, when the above-mentioned mixing ratio exceeds 50% by volume, the viscosity of the electrolyte becomes higher to increase resistance in the battery, which in turn sometimes unpreferably degrades charge and discharge cycle characteristic.

When the above-mentioned mixing ratio of ethylene carbonate is less than 4% by volume, it is difficult to form a stable film on a negative electrode plate, and the cycle characteristic may be unpreferably degraded. When the above-mentioned mixing ratio exceeds 20% by volume, the viscosity of the electrolyte becomes higher to increase resistance in the battery, which in turn sometimes unpreferably degrades charge and discharge cycle characteristic.

When the above-mentioned mixing ratio of propylene carbonate is less than 3% by volume, the effect of suppression of increase in impedance that accompanies charge and discharge cycle becomes smaller, which in turn may unpreferably degrade the cycle characteristic. When the above-mentioned mixing ratio exceeds 17% by volume, the viscosity of the electrolyte becomes higher to increase resistance in the battery, which in turn sometimes unpreferably degrades charge and discharge cycle characteristic.

When the above-mentioned mixing ratio of dimethyl carbonate is not more than 40% by volume, the viscosity of the electrolyte increases to increase resistance in the battery, which in turn sometimes unpreferably degrades charge and discharge cycle characteristic. When the above-mentioned mixing ratio exceeds 60% by volume, the freezing point of the electrolyte rises to increase the resistance in the battery particularly at a low temperature of not higher than −20° C., which in turn sometimes unpreferably degrades cycle characteristic and low temperature characteristic.

As the electrolyte, one obtained by dissolving one or more kinds selected from lithium salts, such as LiClO₄, LiBF₄, LiPF₆, LiAsF₆, LiAlCl₄ and Li(CF₃SO₂)₂N, in the above-mentioned mixed solvent can be used. The electrolyte is adjusted to have a lithium salt concentration of preferably 0.1 mol/L-2 mol/L, more preferably 0.5 mol/L-1.8 mol/L. When the concentration of lithium salt is less than 0.1 mol/L, ion conductivity as an electrolyte cannot be afforded sufficiently, and the function as a battery is unpreferably impaired. When the concentration of lithium salt exceeds 2 mol/L, the viscosity of the electrolyte increases to unpreferably degrades low temperature characteristic and high rate characteristic.

The method for preparing the negative plate is not particularly limited and the plate can be preferably prepared according to a method generally employed in this field. By constituting the above-mentioned positive plate, negative plate and electrolyte in the manner generally employed in this field using a separator, a battery can and the like conventionally used widely, the lithium ion secondary battery of the present invention can be preferably produced.

Now the above-mentioned embodiment (E), which is an embodiment of a preferable combination of negative plate and electrolyte is explained in detail. The negative plate in this embodiment has a current collector and a negative electrode active material layer obtained by forming a layer of a negative electrode active material composition containing a negative electrode active material on the current collector.

The negative electrode active material is a graphitized carbon. As the graphitized carbon, one having a spacing of lattice planes (d002) of 0.3350 nm-0.3360 nm, preferably 0.3352 nm-0.3356 nm, and a crystallite size in the c-axis direction (Lc) of not less than 80 nm, preferably not less than 100 nm, is used. When the above-mentioned spacing of lattice planes is less than 0.3350 nm, the crystallinity becomes too high and decomposition of electrolyte, which is the side reaction in the initial charging, occurs in excess, thereby inconveniently possibly lowering Coulomb efficiency of charging and discharging. When the above-mentioned spacing of lattice planes exceeds 0.3360 nm or the crystallite size in the above-mentioned c-axis direction is less than 80 nm, reversibility of intercalation and de-intercalation reaction of lithium in the negative electrode active material becomes insufficient and charge and discharge capacity [mA·H/g] per carbon weight becomes inconveniently small.

The spacing of lattice planes (d002) and a crystallite size in the c-axis direction (Lc) of graphitized carbon can be measured according to the above-mentioned Japan Society for the Promotion of Science Method.

The Japan Society for the Promotion of Science Method can determine that those having a size of not less than 100 nm have a size of not less than 100 nm, but cannot determine quantitatively. In this embodiment, of those having a spacing of lattice planes (d002) calculated according to the above-mentioned method, which is within the above-mentioned range, and a crystallite size in the c-axis direction (Lc) determine quantitatively, one having a calculated crystallite size in the c-axis direction of not less than 80 nm is used. Of those having a spacing of lattice planes (d002) calculated according to the above-mentioned method, which is within the above-mentioned range, and whose quantitative determination of a crystallite size in the c-axis direction (Lc) was not possible, one having a calculated crystallite size in the c-axis direction of not less than 100 nm is preferably used.

The graphitized carbon to be used has a specific surface area of 0.5 m²/g-8 m²/g, preferably 1.5 m²/g-3 m²/g. When graphitized carbon having the above-mentioned specific surface area of less than 0.5 m²/g is used, the charge and discharge capacity per weight of the negative electrode is degraded, and it is inconveniently unsuitable for the design of a high capacity battery, for example, a battery having the capacity of not less than 1700 mA·H for a 18650 size battery. When the above-mentioned specific surface area exceeds 8 m²/g, a decomposition reaction of propylene carbonate tends to occur during charging to inconveniently degrade the battery capacity of cycle characteristic during charging.

The specific surface area of graphitized carbon can be measured by a gas phase adsorption method (single-point method) in the same manner as in the measurement of the specific surface area of the positive electrode active material in the above-mentioned embodiment (A).

Such graphitized carbon is at least one kind selected from artificial graphite, natural graphite, boron-doped graphite and mesophase graphitized carbon, which has all the above-mentioned spacing of lattice planes, the above-mentioned crystallite size in the c-axis direction and the above-mentioned specific surface area. In the present invention, the above-mentioned graphitized carbon is used as granules, like general graphite type negative electrode active materials. The “granular” in the present invention includes, but is not particularly limited to, scaly, fiber, spherical, pseudo-spherical, bulky, whisker-like and the like.

As the negative electrode active material, one having an average particle size of preferably 5 μm-50 μm, more preferably 10 μm-40 μm is used. When the average particle. size of the negative electrode active material is less than 5 μm, the specific surface area increases, and inconveniently unpreferably promotes the above-mentioned electrolyte decomposition reaction. When the average particle size of the negative electrode active material exceeds 50 μm, the gap between negative electrode active materials becomes too large, thereby preventing easy continuity, as a result of which the resistance increases and inconvenient and unpreferable degradation of cycle characteristic and rate characteristic under a low temperature.

The average particle size of the negative electrode active material can be measured in the same manner as in the measurement of the average particle size of the positive electrode active material in the above-mentioned embodiment (A) by a microtrack particle size analyzer, and calculated.

A binder is added in a proportion of preferably 1 wt %-15 wt %, more preferably 3 wt %-8 wt %, to a negative electrode active material composition. When the amount of the binder is lower than 1 wt %, the adhesion between the negative electrode active material layer and the current collector becomes insufficient to permit easy release, as a result of which the cycle characteristic is unpreferably and inconveniently degraded. When the amount of the binder exceeds 15 wt %; an excess presence of the binder in the negative electrode active material layer, which is an insulator, increases the electrode resistance and the cycle characteristic and rate characteristic are inconveniently preferably degraded.

The electrolyte, a solvent thereof and the mixing ratios of each component are as explained above.

In the above-mentioned embodiment (E), the lithium ion secondary battery has the aforementioned negative plate and electrolyte. By using graphitized carbon having a particular graphitization degree as a negative electrode active material and a mixture of particular cyclic carbonate and chain carbonate in combination as a solvent of the electrolyte, a high capacity lithium ion secondary battery having more superior cycle characteristic and sufficient initial charge and discharge efficiency as compared with conventional lithium ion secondary batteries can be obtained.

The present invention is explained in more detail in the following by referring to Examples, Comparative Examples and evaluation by tests.

### EXAMPLE 1

Li₂CO₃ (46.5 parts by weight) was uniformly mixed with Co₃O₄ (100 parts by weight), and the mixture was sintered at about 980° C. for about 10 hr. The obtained bulky LiCoO₂ was pulverized and classified to give particles having an average particle size of 20 μm. Then the particles were heat treated in the atmosphere at 500° C. for 10 hr to give particles having the crystallite size and coordination number described in Table 1.

### EXAMPLE 2

In the same manner as in Example 1 except that Li₂CO₃ (46 parts by weight) was mixed with Co₃O₄ (100 parts by weight), particles having the crystallite size and coordination number described in Table 1 were obtained.

### EXAMPLE 3

In the same manner as in Example 2 except that heat crystallite size and coordination number described in Table 1 were obtained.

### Comparative Example 1

In the same manner as in Example 1 except that the heat size and coordination number described in Table 1 were obtained.

### Comparative Example 2

In the same manner as in Example 2 except that heat size and coordination number described in Table 1 were obtained.

### Comparative Example 3

In the same manner as in Example 2 except that particles having an average particle size of 1 μm were selected in applied, particles having the crystallite size and coordination number described in Table 1 were obtained.

Using respective lithium cobaltate particles obtained in Examples 1-3 and Comparative Examples 1-3, 90 parts by weight thereof, 3 parts by weight of poly(vinylidene fluoride) as a binder, 7 parts by weight of artificial graphite as a conductive material and 70 parts by weight of N-methylpyrrolidone were mixed to give a slurry. This slurry was applied onto the both sides of a 20 μm thick aluminum foil as a give a positive plate having a positive electrode active material composition layer (20 mg/cm² per one side of the aluminum foil).

Separately, graphitized carbon fiber (90 parts by weight), poly(vinylidene fluoride) (10 parts by weight) and N-methylpyrrolidone (100 parts by weight) were mixed to give a slurry. This slurry was applied onto the both sides of a 14 μm thick copper foil as a negative electrode current collector, dried and roll treated to give a negative plate having a negative electrode active material composition layer (10.4 mg/cm2 per one side of the copper foil).

Then, the positive plate and the negative plate were wound via a porous polyethylene separator to give a cylindrical can type lithium ion secondary battery (discharge capacity: 1600 mA·H, height 65 mm, outer diameter 18 mm). As an electrolyte, a solution of LiPF₆ dissolved at a proportion of 1 mole per 1 L in a mixed solvent (mixed volume ratio: 1:1:3:5) of ethylene carbonate, propylene carbonate, ethylmethyl carbonate and dimethyl carbonate was used, which was immersed between the above-mentioned positive plate and the negative plate.

Evaluation Tests

The respective lithium ion secondary batteries of Examples 1-3 and Comparative Examples 1-3 were subjected to the following tests.

[Rate Characteristic Test]

A 2C discharge was performed at room temperature (20° C.) and the proportion of the discharge capacity relative to the whole capacity was calculated. By the 2C is meant the constant current of 3200 mA to the discharge capacity (1600 mA·H) of the above-mentioned lithium ion secondary battery.

[Low Temperature Characteristic test]

A 1C (i.e., 1600 mA constant current) discharge was performed at −20° C. and the average voltage was measured. The average voltage can be determined by the following formula (V):

$$Average voltage = \frac{discharged electric power [ Wh ]}{discharged electrical quantity [ Ah ]} \qquad ( V )$$

[Cycle Characteristic Test]

A 1C (i.e., 1600 mA constant current) charge and discharge was repeated, and discharge capacity (mA·H) was calculated from the discharge current value and discharge time after 500 cycles. The retention (%) of discharge capacity relative to the initial discharge capacity was calculated from the following formula (VI):

$$Retention ( \% ) of discharge capacity = \frac{discharge capacity after 500 cycles [ mA \cdot H ]}{initial discharge capacity [ mA \cdot H ]} \qquad ( VI )$$

These values are shown in Table 1.

TABLE 1

| | | | | Comp. | Comp. | Comp. |
|---|---|---|---|---|---|---|
| | Ex. 1 | Ex. 2 | Ex. 3 | Ex. 1 | Ex. 2 | Ex. 3 |
| crystallite size | >1000 | 955 | 864 | 732 | 836 | 410 |
| (Å) | | | | | | |
| coordination | 5.8 | 5.8 | 5.9 | 5.6 | 5.6 | 5.9 |
| number of Co—Co | | | | | | |
| 2C discharge | 99 | 99 | 98 | 93 | 91 | 94 |
| capacity(%) | | | | | | |
| average | 3.27 | 3.34 | 3.40 | 2.73 | 2.70 | 2.81 |
| voltage(V) on | | | | | | |
| discharge −20° C. | | | | | | |
| retention(%) of | 75 | 73 | 83 | 49 | 50 | 45 |
| discharge | | | | | | |
| capacity | | | | | | |

From the results of Table 1, it is evident that the lithium ion secondary batteries using the positive electrode active materials of Examples 1-3 for lithium ion secondary batteries are superior in rate characteristic, low temperature characteristic and cycle characteristic. In contrast, it is evident that the lithium ion secondary batteries of Comparative Examples 1-3 are inferior to those of Examples 1-3 in rate characteristice, low temperature characteristic and cycle characteristic, because the crystallite size in the (003) plane direction is less than 800 angstrom or a coordination number of one cobalt atom to a different cobalt atom is less that 5.7.

In the following Examples 4-6, the positive plate of the above-mentioned embodiment(A) was madeusing the positive electrode active material of the present invention and lithium ion secondary batteries were prepared using this plate and subjected to evaluation. The positive electrode active material used and the production method thereof were about the same as those in the above-mentioned Examples 1-3. Therefore, only the main properties of each positive electrode active material are shown in the Table and detailed explanation of the production steps is omitted. The same applies to the following Examples 7-20.

### EXAMPLE4

[Preparation of Positive Plate]

A positive electrode active material composition obtained by uniformly dispersing the positive electrode active material of the present invention LiCoO₂ (91 parts by weight, average particle size: 20 μm, specific surface area: 0.12 m²/g, 20/(average particle size×specific surface area): 8.3), Ketjen black EC (1 part by weight, particle size: 0.01 μm, specific surface area: 700 m²/g) to be a conductive material, spherical graphitized carbon MCMB 6-28 (5 parts by weight, article size: 6 μm specific surface area: 3m²/g) also to be a conductive material, and poly(vinylidene fluoride) (PVdF, 3 parts by weight) to be a binder in N-methylpyrrolidone was mixed in a planetary Despa mixing apparatus (manufactured by ASADA IRON WORKS CO., LTD.) at a rotation of planetary 30 rpm, Despa 500 rpm for 30 min to give a slurry. The average particle size of the above-mentioned positive electrode active material and the particle size of the conductive material were measured using a microtractparticle size analyzer SALD-3000J (SHIMADZU CORPORATION). The specific surface area of the above-mentioned positive electrode active material and conductive material was measured using a specific surface area meter monosorb (QUANTA CHROME CORPORATION). The spacing of lattice planes and the crystallite size in the c-axis direction of the spherical graphitized carbon measured using an X-ray diffractometer RINT2000 (Rigaku Corporation, X-ray source: CuKα ray) under the aforementioned conditions were 0.336 nm and 50 nm, respectively.

The above-mentioned slurry was applied onto the both sides of an aluminum foil (thickness 20 μm) to be a current collector, dried and roll treated under the rolling conditions of rolling temperature of 30° C. and rolling ratio of 30% to form a positive electrode coating layer, whereby a positive plate having 20 mg/cm² LiCoO₂ per one side of the aluminum foil was obtained.

The proportion of the surface of teh positive electrode active material covered with a conductive material was measusred by an element mapping targeting carbon element by EPMA using X-ray microanalyzer JXA-8600MA (manufactured by JEOL Ltd.) and found to be about 5%.

[Preparation of Negative Plate]

Graphitized carbon Melblon Milled FM-14 (95 parts by weight, specific surface area: 1.32 m²/g, spacing of lattice planes: 0.3364 nm, crystallite size in the c-axis direction: 50 nm) to be a negative electrode active material, poly(vinylidene fluoride) (PVdF, 5 parts by weight) to be a binder and N-methylpyrrolidone (50 parts by weight) were mixed to give a sides of an aluminum foil (thickness 20 μm) to be a current slurry and this slurry was applied ontothe both sides of a copper foil (thickness 14 μm) to be a current collector and dried. The spacing of lattice planes and the crystallite size in the c-axis direction of the negative electrode active material were measured in the same manner as in the measurement of the above-mentioned spherical graphitized carbon. Then, this cooper foil was roll treated under the rolling conditions generally employed by those of oridnary skill in the art (rolling temperature: 120° C., rolling ratio: 22%) to give a negative plate.

[Preparation of Electrolyte]

LiPF₆ was dissolved in a mixed solvent of diethyl carbonate (4% by volume), ethylmethyl carbonate (29% by volume), ethylene carbonate (11% by volume), propylene carbonate (9% by volume) and dimethyl carbonate (47% by volume) to a concentration of 1.0 mol/L (relative to electrolyte after preparation) to give an electrolyte.

[Assembly of Lithium Ion Secondary Battery]

The positive plate and the negative plate prepared in the above were wound via a porous polyethylene-polypropylene complex separator and housed in a cylindrical battery can (outer diameter 18 mm, height 650 mm). The electrolyte obtained in teh above was filled in the separator to give the lithium ion secondary battery of the present invention.

### EXAMPLE 5

In the same manner as in Example 4 except that the positive electrode active material composition was mixed at planetary 15 rpm, Despa 500 rpm for 20 min, a lithium ion secondary battery was prepared. In the same manner as in Example 4, the proportion of the surface to be covered with a conductive material of the positive electrode active material was measured and found to be about 10%.

### EXAMPLE 6

In the same manner as in Example 4 except that the positive electrode active material composition was mixed at planetary 10 rpm, Despa 500 rpm for 30 min, a lithium ion secondary battery was prepared. In the same manner as in Example 4, the proportion of the surface to be covered with a conductive material of the positive electrode active material was measured and found to be about 20%.

### Comparative Example 4

In the same manner as in Example 4 except that the positive electrode active material composition was mixed at planetary 60 rpm, Despa 500 rpm for 30 min, a lithium ion secondary battery was prepared. In the same manner as in Example 4, the proportion of the surface to be covered with a conductive material of the positive electrode active material was measured and found to be about 60%.

This Comparative Example is merely an example to confirm characteristics of the above-mentioned embodiment (A), and is encompassed in teh present invention because the positive electrode active material of the present invention is used. The same applies to the following Comparative Examples 5-28.

### Comparative Example 5

In the same manner as in Example 4 except that the positive electrode active material composition was mixed at planetary 50 rpm, Despa 500 rpm for 60 min, a lithium ion secondary battery was prepared. In the same manner as in Example 4, the proportion of the surface to be covered with a conductive material of the positive electrode active material was measured and found to be about 70%.

### Comparative Example 6

In the same manner as in Example 4 except that the positive electrode active material composition was mixed at planetary 60 rpm, Despa 500 rpm for 100 min, a lithium ion secondary battery was prepared. In the same manner as in Example 4, the proportion of the surface to be covered with a conductive material of the positive electrode active material was measured and found to be about 80%.

### Comparative Example 7

In the same manner as in Example 6 except that only scaly graphite (6 parts by weight, particle size: 6 μm, specific surface area: 5 m²/g) was used as a conductive material, a lithium ion secondary battery was prepared.

The lithium ion secondary batteries of Examples 4-6 and Comparative Examples 4-7 prepared as mentioned above were subjected to the cycle characteristic test, low temperature characteristic test, perservation property test and nail penetrate test according to the following procedures.

[Cycle Characteristic Test]

The 1C/1C charge and discharge of the lithium ion secondary batteries obtained above was performed 500 cycles at room temperature (20° C.), and discharge capacity [mA·H] on 1 cycle and 500 cycles is calculated from discharge current and discharge time. The discharge capacity [mA·H] on 500 cycles was divided by discharge capacity [mA·H] on 1 cycle to determine changes [%] in discharge capacity.

[Low Temperature Characteristic Test]

The lithium ion secondary batteries obtained above were charged at room temperature and left standing in the atmosphere at −20° C. for 24 hr. For charging, 1C (1600 mA) constant current was flown to the voltage of 4.2 V, and the current was flown at 4.2 V constant voltage until the total charging time became 2.5 hr. The batteries were discharged in the atmosphere at −20° C. and 0.5 C. (800 mA·H)/2.5 V cutoff, and the discharge capacity [mA·H] then is determined. The batteries were charged and discharged under the same conditions at room temperature (20° C.), and discharge capacity [mA·H] is determined. The discharge capacity at −20° C. was divided by discharge capacity at room temperature to determine changes [%] in discharge capactiy.

In addition, inflection voltage (V) was determined as a voltage of the part at which, in a discharge curve of the above-mentioned discharging at −20° C., the curve showing the voltage shows a convex facing downward.

[Preservation Property Test]

The lithium ion secondary batteries obtained above were charged at room temperature and left standing in the atmosphere at 60° C. for 40 days. For charging, 1C (1600 mA) constant current was flown to the voltage of 4.2 V, and the current was flown at 4.2 V constant voltage until the total charging time became 2.5 hr. The batteries were left standing in the atmosphere at −5° C. for 24 hr and discharged in the atmosphere at −5° C. and 1C (1600 mA·H)/2.5 V cutoff, and the discharge capacity [mA·H] then is determined. The discharge capacity was divided by RT discharge capacity (discharge at 1C (1600 mA-·H)/2.5 V cutoff) to determine changes [%] in discharge capacity. Those that showed changes in the discharge capacity of not less than 50% passed the test and those that showed changes in the discharge capacity of less than 50% failed. The RT discharge capacity here is discharge capacity [mA·H] determined by flowing a 1600 mA constant current until the voltage reached 4.2 V, flowing a current until the total charging time reached 2.5 hr at 4.2 V constant voltage, and discharging in the 20° C. atmosphere at 800 mA and voltage 2.5 V.

[Nail Penetration Test]

The batteries were charged at 1.5A until voltage reached 4.3 V, and immediately after charging, a nail having an outer size of 3 mm was inserted at about the center between each positive electrode terminal and a negative electrode terminal of lithium ion secondary battery at a speed of 4 cm/sec to pierce the battery, thereby performing a safety test checking the number of incident of ignition in 10 batteries.

The results are shown in Table 2.

TABLE 2

| | | | | Comp. | Comp. | Comp. | Comp. |
|---|---|---|---|---|---|---|---|
| | Ex. 4 | Ex. 5 | Ex. 6 | Ex. 4 | Ex. 5 | Ex. 6 | Ex. 7 |
| positive electrode | | | | | | | |
| active material | | | | | | | |
| crystallite | 955 | 955 | 955 | 955 | 955 | 955 | 955 |
| size(Å) | | | | | | | |
| coordination | 5.8 | 5.8 | 5.8 | 5.8 | 5.8 | 5.8 | 5.8 |
| number of Co—Co | | | | | | | |
| 2C discharge | 99 | 100 | 99 | 99 | 99 | 99 | 99 |
| capacity(%) | | | | | | | |
| amount of positive | 91 | 91 | 91 | 91 | 91 | 91 | 91 |
| electrode active material | | | | | | | |
| (parts by weight) | | | | | | | |
| amount of conductive | 6 | 6 | 6 | 6 | 6 | 6 | 6 |
| material(parts by weight) | | | | | | | |
| number of the kind of | 2 | 2 | 2 | 2 | 2 | 2 | 1 |
| conductive materials | | | | | | | |
| presence or absence of | present | present | present | present | present | present | absent |
| conductive material having | | | | | | | |
| particle size of | | | | | | | |
| 1 μm or less | | | | | | | |
| amount of binder(parts by | 3 | 3 | 3 | 3 | 3 | 3 | 3 |
| weight) | | | | | | | |
| proportion(%) of surface of | 5 | 10 | 20 | 60 | 70 | 80 | — |
| positive electrode active | | | | | | | |
| material covered with | | | | | | | |
| conductive material | | | | | | | |
| cycle characteristic(%) | 80 | 77 | 78 | 55 | 57 | 50 | 48 |
| low temperature | | | | | | | |
| characteristic(−20° C.) | | | | | | | |
| discharge capacity(%) | 84 | 82 | 80 | 20 | no | no | no |
| | | | | | discharge | discharge | discharge |
| inflection | 3.30 | 3.32 | 3.28 | 3.02 | 2.65 | 2.90 | 2.80 |
| voltage(V) | | | | | | | |
| preservation property | pass | pass | pass | pass | pass | pass | failure |
| number(nails) of ignition | 0 | 0 | 0 | 2 | 6 | 7 | 0 |
| in nail penetrate test | | | | | | | |

In the following Examples 7 and 8, each positive electrode active material of the present invention was used to prepare the positive plates of the above-mentidned embodiments (B) and (C), and lithium ion secondary batteries using them, which were subjected to evaluation.

### EXAMPLE 7

[preparation of positive plate]

A positive electrode active material composition obtained by dispersing the positive electrode active material of the present invention LiCoO₂ (91 parts by weight, average particle size: 20 μm, specific surface area: 0.12 m²/g, 20/(average particle size×specific surface area): 8.3), spherical graphitized carbon MCMB 6-28 (5 parts by weight, particle size: 6 μm, specific surface area: 3 m²/g) to be a conductive material, Ketjen black EC (1 part by weight, particle size: 0.01 μm, specific surface area: 700 m²/g) also to be a conductive material and poly(vinylidene fluoride) (PVdF, 3 parts by weight) to be a binder in N-methylpyrrolidone was mixing to give a slurry. The average particle size of the above-mentioned positive electrode active material and the particle size of the conductive material were measured using a microtrack particle size analyzer SALD-3000J (SHIMADZU CORPORATION). The specific surface area of the above-mentioned positive electrode active material and conductive material were measured using a specific surface area meter monosorb (QUANTA CHROME CORPORATION). The spacing of lattice planes and the crystallite size in the c-axis direction of the spherical graphitized carbon measured using an X-ray diffractometer RINT2000 (Rigaku Corporation, X-ray source: CuKα ray) under the aforementioned conditions were 0.3360 nm and 60 nm, respectively.

The above-mentioned slurry was applied onto the both sides of an aluminum foil (thickness 20 μm) to be a current collector, dried and roll treated under the rolling conditions of rolling temperature 30° C. and rolling ratio 30% to form a positive electrode coating layer, whereby a positive plate having 20 mg/cm² LiCoO₂ per one side of the aluminum foil was obtained.

The porosity of the positive electrode coating layer was measured by a porosimeter method using mercury and found to be 0.11 cc/g.

[Preparation of Negative Plate]

Graphitized carbon Melblon Milled FM-14 (95 parts by weight, specific surface area: 1.32 m²/g, spacing of lattice planes: 0.3364 nm, crystallite size in the c-axis direction: 50 nm) to be a negative electrode active material, poly(vinylidene fluoride) (PVdF, 5 parts by weight) to be a binder and N-methylpyrrolidone (50 parts by weight) were mixed to give a slurry and this slurry was applied onto the both sides of a copper foil (thickness 14 μm) to be a current collector and dried. The spacing of lattice planes and the crystallite size in the c-axis direction of the negative electrode active material were measured in the same manner as in the measurement of the above-mentioned spherical graphitized carbon. Then, this cooper foil was roll treated under the rolling conditions gnerally employed by those of ordinary skill in the art (rolling temperature: 120° C., rolling ration: 20%) to give a negative plate.

[Preparation of Electrolyte]

LiPF₆ was dissolved in a mixed solvent of diethyl carbonate (4% by volume), ethylmethyl carbonate (29% by volume), ethylene carbonate (11% by volume), propylene carbonate (9% by volume) and dimethyl carbonate (47% by volume) to a concentration of 1.0 mol/L (relative to electrolyte after preparation) to give an electrolyte.

[Assembly of Lithium Ion Secondary Battery]

The positive plate and the negative plate prepared in the above were wound via a porous polyethylene-polypropylene complex separator and housed in a cylindrical battery can (outer diameter 18 mm, height 650 mm) The electrolyte obtained in the above was filled in the separator to give the lithium ion secondary battery of the present invention.

### EXAMPLE 8

In the same manner as in Example 7 except that 5 parts by weight of scaly graphite (particle size: 6 μm, specific surface area: 13 m²/g) and 1 part by weight of the above-mentioned Ketjen black EC were used as conductive materials, a lithium ion secondary battery was prepared. In the same manner as in Example 7, the porosity of the positive electrode coating layer was measured and found to be 0.10 cc/g.

### Comparative Example 8

In the same manner as in Example 7 except that a positive electrode coating layer was formed by roll treatment under rolling conditions of rolling temperature 120° C. and rolling ratio 45%, a lithium ion-secondary battery was prepared. In the same manner as in Example 7, the porosity of the positive electrode coating layer was measured and found to be 0.06 cc/g.

### Comparative Example 9

In the same manner as in Example 7 except that a positive electrode coating layer was formed by roll treatment under rolling conditions of rolling temperature 30° C. and rolling ratio 5%, a lithium ion secondary battery was prepared. In the same manner as in Example 7, the porosity of the positive electrode coating layer was measured and found to be 0.15 cc/g.

### Comparative Example 10

In the same manner as in Example 8 except that a positive electrode coating layer was formed by roll treatment under rolling conditions of rolling temperature 120° C. and rolling ratio 45%, a lithium ion secondary battery was prepared. In the same manner as in Example 7, the porosity of the positive electrode coating layer was measured and found to be 0.05 cc/g.

### Comparative Example 11

In the same manner as in Example 8 except that a positive electrode coating layer was formed by roll treatment under rolling conditions of rolling temperature 30° C. and rolling ratio 5%, a lithium ion secondary battery was prepared. In the same manner as in Example 7, the porosity of the positive electrode coating layer was measured and found to be 0.16 cc/g.

The lithium ion secondary batteries of Examples 7, 8 and Comparative Examples 8-11 prepared as mentioned above were subjected to a battery capacity test, a low temperature characteristic test and a cycle characteristic test according to the following procedures.

[Battery Capacity Test]

A 1600 mA constant current was flown through each lithium ion secondary battery obtained above until the voltage reached 4.2 V, and then the current ws flown for charging at 4.2 V constant voltage until the total charging time became 2.5 hr. Then, the battery was discharged in a 20° C. atmosphere at 800 mA until the voltage became 2.5 V, based on-which discharge capacity [mA·H] was determined.

[Low Temperature Characteristic Test]

The lithium ion secondary batteries obtained above were charged at room temperature and left standing in the atmosphere at −20° C. for 24 hr. For charging, 1C (1600 mA) constant current was flown until the voltage reached 4.2 V, and the current was flown at 4.2 V constant voltage until the total charging time became 2.5 hr. The batteries were discharged in the atmosphere at −20° C. and 0.5 C (800 mA·H)/2.5 V cutoff, and the discharge capacity [mA·H] then is determined. The batteries were charged and discharged under the same conditions at room temprature (20° C.), and discharge capacity [mA·H] is determined. The discharge capacity at −20° C. was divided by discharge capacity at room temperature to determine changes [%] in discharge capacity.

In addition, inflection voltage (V) was determined as a voltage of the part at which, in a discharge curve of the above-mentioned discharging at −20° C., the curve showing the voltage shows a convex facing downward.

[Cycle Characteristic Test]

The 1C/1C charge and discharge of the lithium ion secondary batteries obtained above was performed 500 cycles at room temperature (20° C.), and discharge capacity [mA·H] on 1 cycle and 500 cycles is calculated from discharge current and discharge time. The discharge capacity [mA·H] on 500 cycles was divided by discharge capacity [mA·H] on 1 cycle to determine changes [%] in discharge capacity.

The results are shown in Table 3.

TABLE 3

| | | | Comp. | Comp. | Comp. | Comp. |
|---|---|---|---|---|---|---|
| | Ex. 7 | Ex. 8 | Ex. 8 | Ex. 9 | Ex. 10 | Ex. 11 |
| positive electrode | | | | | | |
| active material | | | | | | |
| crystallite size(Å) | 955 | 955 | 955 | 955 | 955 | 955 |
| coordination | 5.8 | 5.8 | 5.8 | 5.8 | 5.8 | 5.8 |
| number of Co—Co | | | | | | |
| 2C discharge | 99 | 97 | 99 | 99 | 97 | 97 |
| capacity(%) | | | | | | |
| amount of positive electrode | 91 | 91 | 91 | 91 | 91 | 91 |
| active material(parts by | | | | | | |
| weight) | | | | | | |
| amount of conductive material | 6 | 6 | 6 | 6 | 6 | 6 |
| (parts by weight) | | | | | | |
| number of the kind of | 2 | 2 | 2 | 2 | 2 | 2 |
| conductive materials | | | | | | |
| amount of binder(parts by | 3 | 3 | 3 | 3 | 3 | 3 |
| weight) | | | | | | |
| porosity(cc/g) | 0.11 | 0.10 | 0.06 | 0.15 | 0.05 | 0.16 |
| battery capacity(mA · H) | 1630 | 1620 | 1620 | 1500 | 1610 | 1510 |
| low temperatue | | | | | | |
| characteristic(−20° C.) | | | | | | |
| discharge | 85 | 75 | no | 82 | no | 73 |
| capacity(%) | | | discharge | | discharge | |
| inflection | 3.32 | 3.25 | 2.95 | 3.30 | 2.75 | 3.20 |
| voltage (V) | | | | | | |
| cycle characteristic(%) | 93 | 90 | 50 | 60 | 45 | 70 |

As shown in Table 3, the lithium ion secondary batteries of Examples 7 and 8 of the present invention were superior in low temperature characteristic and cycle characteristic, and had battery capacity of not less than 1600 mA·H in a cylindrical battery can (outer diameter 18 mm, height 650 mm). In contrast, the lithium ion secondary batteries of Comparative Examples 8 and 10 having a positive electrode coating layer having a porosity that is less than the range of the present invention could not discharge at a low temperature and were inferior in cycle characteristic as compared to Example batteries. In addition, the lithium ion secondary batteries of Comparative Examples 9 and 11 having a positive electrode coating layer having a porosity that exceeds the range of the present invention showed insufficient battery capacity as compared to Example batteries.

In the following Examples 9-12, the positive plates of the above-mentioned embodiment (D) were prepared using the positive electrode active material of the present invention, and lithium ion secondary batteries using the same were prepared and evaluated.

### EXAMPLE 9

[Preparation of Positive Plate]

A positive electrode active material composition obtained by uniformly dispersing the positive electrode active material of the present invention LiCoO₂ (91 parts by weight, average particle size: 20 μm, specific surface area: 0.12 m²/g, 20/(average particle size×specific surface area): 8.3) to be a positive electrode active material, Ketjen black EC (2 parts by weight, particle size: 0.01 μm, specific surface area: 700 m²/g) to be a conductive material, and poly(vinylidene fluoride) (PVdF, 7 parts by weight) to be a binder in N-methylpyrrolidone was kneaded to give a slurry. This slurry was applied onto the both sides of an aluminum foil (thickness 20 μm) to be a current collector, dried and roll treated under the rolling conditions of rolling temperature 30° C. and rolling ratio 30% to form a positive electrode coating layer, whereby a positive plate having 20 mg/cm² LiCoO₂ per one side of the aluminum foil was obtained. The average particle size of the above-mentioned positiveelectrode active material and the particle size of the conductive material were measured using a microtrack particle size analyzer SALD-3000J (SHIMADZU CORPORATION). The specific surface area of the above-mentioned positive electrode active material and conductive material were measured using a specific surface area meter monosorb (QUANTA CHROME CORPORATION).

The specific surface area of the positive electrode coating layer was measured using a specific surface area meter monosorb (QUANTA CHROME CORPORATION) and found to be 0.9 m²/g.

[Preparation of Negative Plate]

Graphitized carbon Melblon Milled FM-14 (95 parts by weight, specific surface area: 1.32 m²/g, spacing of lattice planes: 0.3364 nm, crystallite size in the c-axis direction: 50 nm) to be a negative electrode active material, poly(vinylidene fluoride) (PVdF, 5 parts by weight) to be a binder and N-methylpyrrolidone (50 parts by weight) were mixed to give a slurry and this slurry was applied onto the both sides of a copper foil (thickness 14 μm) to be a current collector and dried. The spacing of lattice planes and the crystallite size in the c-axis direction of the negative electrode active material were measured using X-ray diffractometer RINT2000 (Rigaku Corporation, X-ray source: CuKα ray) under the aforementioned conditions. Then, this copper foil was roll treated under the rolling conditions generally employed by those of ordinary skill in the art (rolling temperature: 120° C., rolling ratio: 20%) to give a negative plate.

[Preparation of Electrolyte]

LiPF₆ was dissolved in a mixed solvent of diethyl carbonate (4% by volume), ethylmethyl carbonate (29% by volume), ethylene carbonate (11% by volume), propylene carbonate (9% by volume) and dimethyl carbonate (47% by volume) to a concentration of 1.0 mol/L (relative to electrolyte after preparation) to give an electrolyte.

[Assembly of Lithium Ion Secondary Battery]

The positive plate and the negative plate prepared in the above were wound via a porous polyethylene-polypropylene complex separator and housed in a cylindrical battery can (outer diameter 18 mm, height 650 mm). The electrolyte obtained in the above was filled in the separator to give the lithium ion secondary battery of the present invention.

### EXAMPLE 10

In the same manner as in Example 9 except that a mixture of the above-mentioned Ketjen black (1 part by weight) and spherical graphitized carbon MCMB 6-28 (5 parts by weight, particle size: 6 μm (measured by microtrack particle size analyzer SALD-3000J (SHIMADZU CORPORATION)), specific surface area: 3 m²/g (measured by specific surface area meter monosorb (QUANTA CHROME CORPORATION)) was used as a conductive material, and 3 parts by weight of poly(vinylidene fluoride) (PVdF) as a binder, a lithium ion secondary battery was prepared. The spacing of lattice planes and the crystallite size in the c-axis direction of the spherical graphitized carbon measured using an X-ray diffractometer RINT2000 (Rigaku Corporation, X-ray source: CuKα ray) under the aforementioned conditions was 0.3360 nm and 60 nm, respectively. In the same manner as in Example 9, the specific surface area of the positive electrode coating layer was measured and found to be 0.8 m²/g.

### EXAMPLE 11

In the same manner as in Example 10 except that a mixture of the above-mentioned Ketjen black (1 part by weight) and scaly graphite KS-6 (5 parts by weight, particle size: 6 μm (measured by microtrack particle size analyzer SALD-3000J (SHIMADZU CORPORATION)), specific surface area: 13 m²/g (measured by specific surface area meter monosorb (QUANTA CHROME CORPORATION)) was used as a conductive material, a lithium ion secondary battery was prepared. In the same manner as in Example 9, the specific surface area of the positive electrode coating layer was measured and found to be 0.7 m²/g.

### EXAMPLE 12

In the same manner as in Example 10 except that a mixture of the above-mentioned Ketjen black (1 part by weight), the above-mentioned spherical graphitized carbon (3 parts by weight) and the above-mentioned scaly graphite (2 parts by weight) was used as a conductive material, a lithium ion secondary battery was prepared. In the same manner as in Example 9, the specific surface area of the positive electrode coating layer was measured and found to be 0.8 m²/g.

### Comparative Example 12

In the same manner as in Example 9 except that a positive electrode coating layer was formed by rolling at a rolling temperature of 120° C., a lithium ion secondary battery was prepared. In the same manner as in Example 9, the specific surface area of the positive electrode coating layer was measured and found to be 0.4 m²/g.

### Comparative Example 13

In the same manner as in Example 9 except that a positive electrode coating layer was formed by rolling at a rolling ratio of 5%, a lithium ion secondary battery was prepared. In the same manner as in Example 9, the specific surface area of the positive electrode coating layer was measured and found to be 1.3 m²/g.

### Comparative Example 14

In the same manner as in Example 10 except that 6 parts by weight of the above-mentioned spherical graphitized carbon alone was added as a conductive material, a lithium ion secondary battery was prepared. In the same manner as in Example 9, the specific surface area of the positive electrode coating layer was measured and found to be 0.8 m²/g.

### Comparative Example 15

In the same manner as in Example 10 except that 6 parts by weight of the above-mentioned scaly graphite alone was added as a conductive material, a lithium ion secondary battery was prepared. In the same manner as in Example 9, the specific surface area of the positive electrode coating layer was measured and found to be 0.9 m²/g.

### Comparative Example 16

In the same manner as in Example 10 except that a mixture of the above-mentioned spherical graphitized carbon (3 parts by weight) and the above-mentioned scaly graphite (3 parts by weight) was used as a conductive material, a lithium ion secondary battery was prepared. In the same manner as in Example 9, the specific surface area of the positive electrode coating layer was measured and found to be 0.7 m²/g.

The lithium ion secondary batteries of Examples 9-12 and Comparative Examples 12-16 prepared as mentioned above were subjected to a battery capacity test, a low temperature characteristic test and a cycle characteristic test according to the following procedures. [Battery Capactiy Test]

For charging, a 1600 mA constant current was flown through each lithium ion secondary battery obtained above until the voltage reached 4.2 V, and then the current was flown at 4.2 V constant voltage until the total charging time became 2.5 hr. Then, the battery was discharged in a 20° C. atmosphere at 800 mA until the voltage became 2.5 V, based on which discharge capacity [mA·H] was determined.

[Low Temperature Characteristic Test]

The lithium ion secondary batteries obtained above were charged at room temperature and left standing in the atmosphere at −20° C. for 24 hr. For charging, 1C. (1600 mA) constant current was flown until the voltage reached 4.2 V, and the current was flown at 4.2 V constant voltage until the total charging time became 2.5 hr. The batteries were discharged in the atmosphere at −20° C. and 0.5C. (800 mA·H)/2.5 V cutoff, and the discharge capacity [mA·H] then is determined. The batteries were charged and discharged under the same conditions at room temperature (20° C.), and discharge capacity [mA·H] is determined. The discharge capacity at −20° C. was divided by discharge capacity at room temperature to determine changes [%] in discharge capacity.

[Preservation Property Test]

A 1600 mA constant current was flown until the voltage reached 4.2 V, and then a current was flown at 4.2 V constant voltage until the total charging time became 2.5 hr for charging, whereby full charge state was achieved. The battery was left standing under a 60° C. atmosphere for 40 days, placed in a −10° C. chamber, and allowed to discharge for 12 hr. This battery was subjected to 1600 mA constant current discharge and the preservation property was judged by the voltage showing a convex facing downward in a discharge curve then.

[Cycle Characteristic Test]

The 1C/1C charge and discharge of the lithium ion secondary batteries obtained above was performed 100 cycles at room temperature (20° C.), and discharge capacity [mA·H] on 1 cycle and 100 cycles is calculated from discharge current and discharge time. The discharge capacity [mA·H] on 100 cycles was divided by discharge capacity [mA·H] on 1 cycle to determine changes [%] in discharge capacity.

The results are shown in Table 4.

TABLE 4

| | | | | | Comp. | Comp. | Comp. | Comp. | Comp. |
|---|---|---|---|---|---|---|---|---|---|
| | Ex. 9 | Ex. 10 | Ex. 11 | Ex. 12 | Ex. 12 | Ex. 13 | Ex. 14 | Ex. 15 | Ex. 16 |
| positive electrode | | | | | | | | | |
| active material | | | | | | | | | |
| crystallite size(Å) | 955 | 955 | >1000 | 864 | 955 | 955 | 955 | 955 | 955 |
| coordination | | | | | | | | | |
| material number of Co—Co | 5.8 | 5.8 | 5.8 | 5.9 | 5.8 | 5.8 | 5.8 | 5.8 | 5.8 |
| 2C discharge | 100 | 99 | 98 | 99 | 100 | 100 | 99 | 99 | 99 |
| capacity(%) | | | | | | | | | |
| amount of positive | 91 | 91 | 91 | 91 | 91 | 91 | 91 | 91 | 91 |
| electrode active | | | | | | | | | |
| material(parts by | | | | | | | | | |
| weight) | | | | | | | | | |
| amount of conductive | | | | | | | | | |
| material(parts by | | | | | | | | | |
| weight) | | | | | | | | | |
| Ketjen black | 2 | 1 | 1 | 1 | 2 | 2 | — | — | — |
| spherical graphitized | — | 5 | — | 3 | — | — | 6 | — | 3 |
| carbon | | | | | | | | | |
| scaly graphite | — | — | 5 | 2 | — | — | — | 6 | 3 |
| amount of binder | 7 | 3 | 3 | 3 | 7 | 7 | 3 | 3 | 3 |
| (parts by weight) | | | | | | | | | |
| specific area(m²/g) of | 0.9 | 0.8 | 0.7 | 0.8 | 0.4 | 1.3 | 0.8 | 0.9 | 0.7 |
| positive electrode | | | | | | | | | |
| coated layer | | | | | | | | | |
| battery capacity(mA · H) | 1620 | 1610 | 1617 | 1610 | 1610 | 1480 | 1610 | 1608 | 1605 |
| low temperature | 3.39 | 3.42 | 3.28 | 3.31 | 2.99 | 3.28 | 2.88 | 2.97 | 2.85 |
| characteristic(V) | | | | | | | | | |
| preservation property(V) | 3.28 | 3.31 | 3.22 | 3.26 | 2.84 | 3.15 | 2.77 | 2.76 | 2.81 |
| cycle characteristic(%) | 93 | 94 | 93 | 92 | 85 | 60 | 84 | 82 | 83 |

As shown in Table 4, the lithium ion secondary batteries of Examples 9-12 of the present invention showed superior low temperature characteristic, preservation property and cycle characteristic, and had battery capacity of not less than 1600 mA·H in a cylindrical battery can having an outer diameter of 18 mm and a height of 650 mm. In contrast, the lithium ion secondary battery of Comparative Example 12 having a positive electrode coated layer having a specific surface area that was less than the range of the present invention was inferior in low temperature characteristic and cycle characteristic as compared to Example batteries. In addition, the lithium ion secondary battery of Comparative Example 13 having a positive electrode coating layer having a specific surface area that exceeds the range of the present invention showed insufficient battery capacity. Moreover, the lithium ion secondary batteries of Comparative Examples 14-16, wherein a specific surface area of the positive electrode coating layer is within the range of the present invention but carbon black is not contained as the conductive material, were inferior in low temperature characteristic and cycle characteristic to Example batteries of Examples 9-12.

In the following Examples 13-20, lithium ion secondary batteries were prepared using the positive electrode active material of the present invention, and according to the above-mentioned embodiment (E) (embodiment of preferable combination of negative plate and electrolyte), and evaluated.

### EXAMPLE 13

[Preparation of Negative Plate]

Natural graphite (90 parts by weight, spacing of lattice planes: 0.3354 nm, crystallite size in the c-axis direction: not less than 100 nm, specific surface area: 4 m²/g, measured by specific surface area meter monosorb (QUANTA CHROME CORPORATION), average particle size: 25 μm (measured by microtrack particle size analyzer SALD-3000J (SHIMADZU CORPORATION)) (hereinafter to be referred to as negative electrode active material a)) to be a negative electrode active material, and poly(vinylidene fluoride) (PVdF, 10 parts by weight) to be a binder were mixed to give a slurry and this slurry was applied onto the both sides of a copper foil (thickness 14 μm) to be a current collector and dried. Then, this copper foil was roll treated to give a negative plate having 8 mg/cm²-12 mg/cm² of natural graphite per one surface of the copper foil. The spacing of lattice planes and the crystallite size in the c-axis direction of the negative electrode active material were measured using X-ray diffractometer RINT2000 (Rigaku Corporation, X-ray source: CuKα ray) under the aforementioned conditions.

[Preparation of Positive Plate]

A positive electrode active material composition obtained by uniformly dispersing the positive electrode active material of the present invention LiCoO₂ (91 parts by weight, average particle size: 20 μm (measured by microtrack particle size analyzer SALD-3000J (SHIMADZU CORPORATION)), spherical graphite (5 parts by weight, particle size: 6 μm (measured by microtrack particle size analyzer SALD-3000J (SHIMADZU CORPORATION)) and 1 part by weight of oil furnace black (average particle size: 30 nm (measured by microtrack particle conductive material and poly (vinylidene fluoride) (PVdF, 3 parts by weight) to be a binder in N-methylpyrrolidone was size analyzer SALD-3000J (SHIMADZU CORPORATION)) to be a kneaded to give a slurry.

The above-mentioned slurry ws pplied onto the both sides of an aluminum foil (thickness 20 μm) to be a current collector, dried and roll treated to give a positive plate having 15 mg/cm²-25 mg/cm² LiCoO₂ per one side of the aluminum foil. [Prerparation of Electrolyte]

LiPF₆ was dissolved in a mixed solvent of ethylene carbonate (EC, 11% by volume), propylene carbonate (PC, 9% by volume), diethyl carbonate (DEC, 4% by volume), ethylmethyl carbonate (EMC, 29% by volume) and dimethyl carbonate (DMC, 47% by volume) to a concentration of 1.0 mol/L (relative to electrolyte after preparation) to give an electrolyte (hereinafter to be referred to as electrolyte A).

[Assembly of Lithium Ion Secondary Battery]

The positive plate and the negative plate prepared in the above were wound via a porous polyethylene-polypropylene complex separator and hosed in a cylindricl battery can (outer diameter 18 mm, height 650 m). The electrolytem obtained in the above was filled in the separator to give the lithium ion secondary battery of 18650 size of the present invention.

### Comparative Example 17

In the same manner as in Example 13 except that an electrolyte (hereinafter to be referred to as electrolyte B) prepared by dissolving LiPF₆ in a mixed solvent of 25% by volume of ethylene carbonate (EC), 50% by volume of ethylmethyl carbonate (EMC) and 25% by volume of dimethyl carbonate (DMC) to a concentration of 1.0 mol/L (relative to electrolyte after preparation) was used as the electrolyte, a lithium ion secondary battery was prepared.

### Comparative Example 18

In the same manner as in Example 13 except that an electrolyte (hereinafter to be referred to as electrolyte C) prepared by dissolving LiPF₆ in a mixed solvent of 30% by volume of ethylene carbonate (EC), 20% by volume of propylene carbonate (PC) and 50% by volume of diethyl carbonate (DEC) to a concentration of 1.0 mol/L (relative to electrolyte after preparation) was used as the electrolyte, a lithium ion secondary battery was prepared.

### Example 14

In the same manner as in Example 13 except that artificial graphite (spacing of lattice planes: 0.3354 nm, crystallite size in the c-axis direction: not less than 100 nm, specific surface area: 2 m²/g, average particle size: 25 μm) (hereinafter to be referred to as negative electrode active material b) was used as the negative electrode active material, a lithium ion secondary battery was prepared.

### Comparative Example 19

In the same manner as in Example 14 except that the above-mentioned electrolyte B was used as an electrolyte, a lithium ion secondary battery was prepared.

### Comparative Example 20

In the same manner as in Example 14 except that the above-mentioned electrolyte C was used as an electrolyte, a lithium ion secondary battery was prepared.

### EXAMPLE 15

In the same manner as in Example 13 except that boron-doped graphite (spacing of lattice planes: 0.3354 nm, crystallite size in the c-axis direction: not less than 100 nm, specific surface area: 1 m²/g, average particle size: 20 μm) (hereinafter to be referred to as negative electrode active material c) was used as the negative electrode active material, a lithium ion secondary battery was prepared.

### Comparative Example 21

In the same manner as in Example 15 except that the above-mentioned electrolyte B was used as an electrolyte, a lithium ion secondary battery was prepared.

### Comparative Example 22

In the same manner as in Example 15 except that the above-mentioned electrolyte C was used as an electrolyte, a lithium ion secondary battery was prepared.

### Comparative Example 23

In the same manner as in Example 13 except that mesophase pitch graphitized carbon fiber (spacing of lattice planes: 0.3362 nm, crystallite size in the c-axis direction: 50 nm, specific surface area: 1 m²/g, fiber diameter: 8 μm) (hereinafter to be referred to as negative electrode active material d) was used as a negative electrode active material, a lithium ion secondary battery was prepared.

### Comparative Example 24

In the same manner as in Example 13 except that the above-mentioned negative electrode active material d was used as a negative electrode active material and the above-mentioned electrolyte B was used as an electrolyte, a lithium ion secondary battery was prepared.

### Comparative Example 25

In the same manner as in Example 13 except that the above-mentioned negative electrode active material d was used as a negative electrode active material and the above-mentioned electrolyte C was used as an electrolyte, a lithium ion secondary battery was prepared.

### EXAMPLE 16

In the same manner as in Example 13 except that boron-doped graphite (spacing of lattice planes: 0.3351 nm, crystallite size in the c-axis direction: not less than 100 nm, specific surface area: 1.5 m²/g, average particle size: 20 μm) (hereinafter to be referred to as negative electrode active material e) was used as a negative electrode active material, a lithium ion secondary battery was prepared.

### EXAMPLE 17

In the same manner as in Example 13 except that mesophase pitch graphitized carbon fiber (spacing of lattice planes: 0.3356 nm, crystallite size in the c-axis direction: 80 nm, specific surface area: 1 m²/g, fiber diameter: 10 μm) (hereinafter to be referred to as negative electrode active material f) was used as a negative electrode active material, a lithium ion secondary battery was prepared.

### EXAMPLE 18

In the same manner as in Example 13 except that artificial graphite (spacing of lattice planes: 0.3354 nm, crystallite size in the c-axis direction: not less than 100 nm, specific surface area: 7 m²/g, average particle size: 10 μm) (hereinafter to be referred to as negative electrode active material g) was used as a negative electrode active material, a lithium ion secondary battery was prepared.

### Comparative Example 26

In the same manner as in Example 13 except that artificial graphite (spacing of lattice planes: 0.3354 nm, crystallite size in the c-axis direction: not less than 100 nm, specific surface area: 10 m²/g, average particle size: 3 μm) (hereinafter to be referred to as negative electrode active material h) was used as a negative electrode active material, a lithium ion secondary battery was prepared.

### EXAMPLE 19

In the same manner as in Example 13 except that negative electrode active material b was used as a negative electrode active material and an electrolyte (hereinafter to be referred to as electrolyte D) prepared by dissolving LiPF₆ in a mixed solvent of 10% by volume of ethylene carbonate (EC), 15% by volume of propylene carbonate (PC), 4% by volume of diethyl carbonate (DEC), 27% by volume of ethylmethyl carbonate (EMC) and 44% by volume of dimethyl carbonate (DMC) to a concentration of 1.0 mol/L (relative to electrolyte after preparation) was used as an electrolyte, a lithium ion secondary battery was prepared.

### EXAMPLE 20

In the same manner as in Example 13 except that negative electrode active material b was used as a negative electrode active material and an electrolyte (hereinafter to be referred to as electrolyte E) prepared by dissolving LiPF₆ in a mixed solvent of 11% by volume of ethylene carbonate (EC), 5% by volume of propylene carbonate (PC), 4% by volume of diethyl carbonate (DEC), 31% by volume of ethylmethyl carbonate (EMC) and 50% by volume of dimethyl carbonate (DMC) to a concentration of 1.0 mol/L (relative to electrolyte after preparation) was used as an electrolyte, a lithium ion secondary battery was prepared.

### Comparative Example 27

In the same manner as in Example 13 except that negative electrode active material b was used as a negative electrode active material and an electrolyte (hereinafter to be referred to as electrolyte F) prepared by dissolving LiPF₆ in a mixed solvent of 20% by volume of ethylene carbonate (EC), 20% by volume of propylene carbonate (PC), 30% by volume of diethyl carbonate (DEC) and 30% by volume of ethylmethyl carbonate (EMC) to a concentration of 1.0 mol/L (relative to electrolyte after preparation) was used as an electrolyte, a lithium ion secondary battery was prepared.

### Comparative Example 28

In the same manner as in Example 13 except that negative electrode active material b was used as a negative electrode active material and an electrolyte (hereinafter to be referred to as electrolyte G) prepared by dissolving LiPF₆ in a mixed solvent of 32% by volume of ethylene carbonate (EC), 19% by volume of diethyl carbonate (DEC), 36% by volume of ethylmethyl carbonate (EMC) and 14% by volume of dimethyl carbonate (DMC) to a concentration of 1.0 mol/L (relative to electrolyte after preparation) was used as an electrolyte, a lithium ion secondary battery was prepared.

The lithium ion secondary batteries of Examples 13-20 and Comparative Examples 17-28 prepared as mentioned above were subjected to a battery capacity test and a cycle characteristic test according to the following procedures.

[Battery Capacity Test]

A 1700 mA constant current was flown through each lithium ion secondary battery obtained above until the voltage reached 4.2 V, and then the current was flown for charging at 4.2 V constant voltage until the total charging time became 3 hr. Then, the battery was discharged in a 20° C. atmosphere at 1700 mA until the voltage became 3 V, based on which discharge capacity [mA·H] of the initial charge-discharge was determined. The initial discharge capacity was divided by the initial charge capacity to determine the initial charge-discharge efficiency [%].

[Cycle Characteristic Test]

Each lithium ion secondary battery was subjected to 300 cycles of the following 4 steps (4 steps being 1 cycle) at room temperature (20° C.): (1) 3 hr charging with a 1700 mA constant current with the upper limit of voltage being 4.2 V, (2) 0.5 hr pause after charging, (3) discharging with a 1700 mA constant current until the voltage reaches 3 V and (4) 0.5 hr pause after discharge. The discharge capacity (mA·H) was calculated from the discharge current and discharge time at the 100th cycles and the 300th cycles. The discharge capacity at each cycle was divided by the initial discharge capacity and the capacity retention [%] at 100th cycles and 300th cycles was calculated.

The results of the above-mentioned respective tests are shown in Table 5 for Examples 13-20, Table 6 for Comparative Examples 17-22 and Table 7 for Comparative Examples 23-28.

TABLE 5

| | Ex. 13 | Ex. 14 | Ex. 15 | Ex. 16 | Ex. 17 | Ex. 18 | Ex. 19 | Ex. 20 |
|---|---|---|---|---|---|---|---|---|
| positive electrode | | | | | | | | |
| active material | | | | | | | | |
| crystallite size(Å) | 955 | 955 | 955 | 955 | 955 | >1000 | >1000 | 864 |
| coordination | 5.8 | 5.8 | 5.8 | 5.8 | 5.8 | 5.8 | 5.8 | 5.9 |
| number of Co—Co | | | | | | | | |
| 2C discharge | 96 | 99 | 98 | 98 | 99 | 99 | 100 | 98 |
| capacity(%) | | | | | | | | |
| negative electrode | a | b | c | e | f | g | b | b |
| active material | | | | | | | | |
| electrolyte | A | A | A | A | A | A | D | E |
| initial time | | | | | | | | |
| charge-discharge | | | | | | | | |
| discharge capacity | 1720 | 1720 | 1710 | 1750 | 1695 | 1720 | 1700 | 1720 |
| (mA · H) | | | | | | | | |
| charge-discharge | 90 | 90 | 91 | 90 | 92 | 89 | 88 | 92 |
| efficiency(%) | | | | | | | | |
| cycle characteristic | | | | | | | | |
| 100 cycles | | | | | | | | |
| discharge capacity | 1600 | 1600 | 1607 | 1593 | 1593 | 1565 | 1513 | 1531 |
| (mA · H) | | | | | | | | |
| capacity retention(%) | 93 | 93 | 94 | 91 | 94 | 91 | 89 | 89 |
| 300 cycles | | | | | | | | |
| discharge capacity | 1445 | 1428 | 1454 | 1418 | 1441 | 1393 | 1326 | 1342 |
| (mA · H) | | | | | | | | |
| capacity retention(%) | 84 | 83 | 85 | 81 | 85 | 81 | 78 | 78 |

TABLE 6

| | Comp. | Comp. | Comp. | Comp. | Comp. | Comp. |
|---|---|---|---|---|---|---|
| | Ex. 17 | Ex. 18 | Ex. 19 | Ex. 20 | Ex. 21 | Ex. 22 |
| positive electrode | | | | | | |
| active material | | | | | | |
| crystallite size(Å) | 955 | 955 | 955 | 955 | 955 | 955 |
| coordination number | 5.8 | 5.8 | 5.8 | 5.8 | 5.8 | 5.8 |
| of Co-Co | | | | | | |
| 2C discharge | 96 | 96 | 99 | 99 | 98 | 98 |
| capacity(%) | | | | | | |
| negative electrade active | a | a | b | b | c | c |
| material | | | | | | |
| electralyte | B | C | B | C | B | C |
| initial time | | | | | | |
| charge-discharge | | | | | | |
| discharge capacity | 1730 | 1400 | 1720 | 1365 | 1720 | 1400 |
| (mA · H) | | | | | | |
| charge-discharge | 91 | 70 | 90 | 65 | 92 | 70 |
| efficiency(%) | | | | | | |
| cycle characteristic | | | | | | |
| 100 cycles | | | | | | |
| discharge capacity | 1419 | 1218 | 1376 | 1201 | 1445 | 1232 |
| (mA · H) | | | | | | |
| capacity retention(%) | 1419 | 1218 | 1376 | 1201 | 1445 | 1232 |
| 300 cycles | | | | | | |
| discharge capacity | 1038 | 938 | 1049 | 901 | 1066 | 952 |
| (mA · H) | | | | | | |
| capacity retention(%) | 60 | 67 | 61 | 66 | 62 | 68 |

TABLE 7

| | Comp. | Comp. | Comp. | Comp. | Comp. | Comp. |
|---|---|---|---|---|---|---|
| | Ex. 23 | Ex. 24 | Ex. 25 | Ex. 26 | Ex. 27 | Ex. 28 |
| positive electrode | | | | | | |
| active material | | | | | | |
| crystallite size(Å) | 955 | 955 | 955 | 955 | 955 | 955 |
| coordination number | 5.8 | 5.8 | 5.8 | 5.8 | 5.8 | 5.8 |
| of Co—Co | | | | | | |
| 2C discharge | 96 | 96 | 96 | 96 | 96 | 96 |
| capacity(%) | | | | | | |
| negative electrade active | d | d | d | h | b | b |
| material | | | | | | |
| electralyte | A | B | C | E | F | G |
| initial time | | | | | | |
| charge-discharge | | | | | | |
| discharge capacity | 1680 | 1680 | 1600 | 1720 | 1690 | 1720 |
| (mA · H) | | | | | | |
| charge-discharge | 92 | 92 | 80 | 94 | 85 | 90 |
| efficiency(%) | | | | | | |
| cycle characteristic | | | | | | |
| 100 cycles | | | | | | |
| discharge capacity | 1512 | 1344 | 1376 | 1393 | 1403 | 1393 |
| (mA · H) | | | | | | |
| capacity retention(%) | 90 | 80 | 86 | 81 | 83 | 81 |
| 300 cycles | | | | | | |
| discharge capacity | 1344 | 1008 | 1088 | 1066 | 980 | 980 |
| (mA · H) | | | | | | |
| capacity retention(%) | 80 | 60 | 68 | 62 | 58 | 57 |

As is clear from the above-mentioned Table, the lithium ion secondary batteries of Examples 13-20 of the present invention respectively comprise negative electrode active materials a-c, e-g, which are graphitized carbons, and although the electrolyte comprised propylene carbonate and ethylene carbonate in combination, they exhibited superior cycle characteristic and high battery capacity of not less than 1700 mA·H as a 18650 size battery can.

In contrast, the lithium ion secondary batteries of Comparative Examples 17, 19 and 21 comprised electrolyte B free of propylene carbonate, and therefore, were inferior in cycle characteristic as compared to Examples 13-15.

In addition, because the lithium ion secondary batteries of Comparative Examples 18, 20 and 22 comprised propylene carbonate in a proportion of 20% by volume, the initial charge-discharge efficiency was lower as compared to Examples 13-15, thus failing to show predetermined discharge capacity.

The lithium ion secondary batteries of Comparative Examples 23-25 failed to show battery capacity of not less than 1700 mA·H unlike Examples 13-15, due to a smaller capacity afforded by the graphitization degree of the negative electrode active material d.

The lithium ion secondary battery of Comparative Example 26 showed lower battery capacity in the cycle characteristics, because the specific surface area of the negative electrode active material h was too large, where even the use of electrolyte A as in Examples 13-18 led to easy occurrence of decomposition reaction of propylene carbonate.

Comparative Example 27, where electrolyte F free of dimethyl carbonate was used, and Comparative Example 28 where electrolyte G free of propylene carbonate was used, were inferior in cycle characteristic as compared to any of Examples 13-20.

### Industrial Applicability

By the use of a positive electrode containing the positive electrode active material specified in the present invention for a lithium ion secondary battery, the rate characteristic, low temperature characteristic and cycle characteristic of the lithium ion secondary battery can be improved.

In addition, by the use of this positive electrode active material and by constituting a positive plate of the above-mentioned embodiments (A)-(D) as a more preferable embodiment of the positive plate, a high grade positive plate for lithium ion secondary battery having sufficient battery capacity, which is superior in cycle characteristic, preservation property, safety and low temperature characteristic, as well as a lithium ion secondary battery using the same, can be provided. Such lithium ion secondary battery can be suitably used for observation equipment, communication instruments, and further for instruments assumed to be used at low temperatures, such as electric automobiles and power storage apparatuses.

Furthermore, by making a negative plate and an electrolyte of the above-mentioned embodiment (E) using this positive electrode active material, the cycle characteristic can be enhanced, and the battery shows superior efficiency of initial time charge-discharge and has high capacity. Therefore, it can be preferably used for various electric instruments, particularly portable devices, such as cellular phones and note type personal computers.

This application is based on patent application Nos. 152649/2000, 164577/2000, 164592/2000, 164614/2000 and 167310/2000 filed in Japan, the contents of which are hereby incorporated by reference.

What is claimed is:

1. A positive electrode active material for lithium ion secondary battery, wherein lithium cobaltate has a crystallite size in the direction of (003) plane of not less than 800 angstrom and a coordination number of a cobalt atom to a different cobalt atom is not less than 5.7.

2. A positive plate for lithium ion secondary battery comprising a current collector and a positive electrode coating layer formed thereon, which comprises the positive electrode active material of claim 1 and a conductive material having a particle size of not more than 1 μm, wherein not more than 50% of a surface of the positive electrode active material in the positive electrode coating layer is covered with the conductive material.

3. A positive plate for lithium ion secondary battery comprising a current collector and a positive electrode coating layer formed thereon, which comprises the positive electrode active material of claim 1 and a conductive material having a particle size of not less than 3 μm and a conductive material having a particle size of not more than 2 μm, wherein the positive electrode coating layer has a porosity of 0.08 cc/g-0.14 cc/g.

4. A positive plate for lithium ion secondary battery comprising a current collector and a positive electrode coating layer formed thereon, which comprises the positive electrode active material of claim 1 and a conductive material having a particle size of not more than 10 μm, wherein the positive electrode coating layer has a porosity of 0.08 cc/g-0.14 cc/g.

5. A positive plate for lithium ion secondary battery comprising a current collector and a positive electrode coating layer formed thereon, which comprises the positive electrode active material of claim 1 and a conductive material comprising at least carbon black, wherein the positive electrode coating layer has a specific surface area of 0.5 m²/g-1.0 m²/g.

6. The positive plate for lithium ion secondary battery according to any of claims 2 to 5, wherein the positive electrode active material has an average particle size of not less than 10 μm.

7. The positive plate for lithium ion secondary battery according to claim 6, wherein a value obtained by dividing 20 by a product of an average particle size of the positive electrode active material and a specific surface area of the positive electrode active material is 7-9.

8. A lithium ion secondary battery comprising a positive plate comprising the positive electrode active material of claim 1.

9. The lithium ion secondary battery of claim 8, wherein said positive plate is the positive plate of claim 2.

10. The lithium ion secondary battery of claim 8, wherein said positive plate is the positive plate of claim 3.

11. The lithium ion secondary battery of claim 8, wherein said positive plate is the positive plate of claim 4.

12. The lithium ion secondary battery of claim 8, wherein said positive plate is the positive plate of claim 5.

13. The lithium ion secondary battery of claim 8, which comprises a negative plate comprising a graphitized carbon having a spacing of lattice planes (d002) of 0.3350 nm-0.3360 nm, a crystallite size in the c-axis direction (Lc) of not less than 80 nm and a specific surface area of 0.5 m²/g-8 m²/g as a negative electrode active material, and an electrolyte comprising a mixture of ethylene carbonate, propylene carbonate, dimethyl carbonate and at least one kind selected from diethyl carbonate and ethylmethyl carbonate, as a solvent.

14. The lithium ion secondary battery of claim 13, wherein a mixing ratio of at least one kind selected from diethyl carbonate and ethylmethyl carbonate is 25% by volume-50% by volume, a mixing ratio of ethylene carbonate is 4% by volume-20% by volume, a mixing ratio of propylene carbonate is 3% by volume-17% by volume and a mixing ratio of dimethyl carbonate is more than 40% by volume and not more than 60% by volume.

15. The lithium ion secondary battery of claim 13, wherein the graphitized carbon is at least one kind selected from artificial graphite, natural graphite, boron-doped graphite and mesophase graphitized carbon.

16. A production method of a positive electrode active material for lithium ion secondary battery, which comprises mixing lithium carbonate and cobalt oxide at a compounding ratio in a lithium/cobalt atom ratio of 0.99-1.10, sintering to give a sintered product mass, pulverizing the sintered product to give a particles and heat treating the particles at a temperature of 400-750° C. for 0.5-50 hr.

17. The production method of claim 16, which comprises passing the pulverized particles through a sieve to classify the average particle size of the particles to 1 μm-30 μm, prior to the above-mentioned heat treatment.

18. A production method of a positive plate for lithium ion secondary battery, which comprises applying a positive electrode active material composition comprising the positive electrode active material of claim 1 and a conductive material containing at least carbon black on a current collector, drying the composition and rolling at a rolling temperature of 20° C.-100° C. and a rolling rate of 10%-40% to form a positive electrode coat layer.
